(19) United States
(12) Patent Application Publication
(10) Pub. No.: US 2021/0183096 A1
(43) Pub. Date: Jun. 17, 2021

(54) IMAGE PROCESSING APPARATUS, IMAGING APPARATUS, IMAGE PROCESSING METHOD AND PROGRAM

(71) Applicant: SONY CORPORATION, TOKYO (JP)

(72) Inventors: MASATOSHI YOKOKAWA, KANAGAWA (JP); KAZUNORI KAMIO, KANAGAWA (JP); TAKAHIRO NAGANO, KANAGAWA (JP)

(21) Appl. No.: 16/081,749

(22) PCT Filed: Feb. 27, 2017
(86) PCT No.: PCT/JP2017/007463

§ 371 Date: Aug. 31, 2018

(30) Foreign Application Priority Data
Mar. 15, 2016 (JP) 2016-050426

(51) Int. Cl. G06T 7/73

(52) U.S. Cl. CPC G06T 7/74; G06T 2207/10048; G06T 2207/10012

(57) ABSTRACT

Provided are an apparatus and a method for generating accurate distance information of a subject. The apparatus has an image processing unit which inputs a first image constituted by a visible light component and a second image including a visible light component and an infrared light component to calculate a subject distance, in which an image processing unit calculates two distance information of a TOF distance, which is the subject distance calculated according to a TOF system by utilizing the second image, and a stereo distance calculated according to a stereo system by utilizing the first image and the second image, determines TOF distance reliability indicating reliability of the TOF distance, and generates, as final distance information, the stereo distance, which is the subject distance according to the stereo system, or distance information calculated by synthesis processing of the TOF distance and the stereo distance, for a pixel region in which the reliability of the TOF distance is low.

### TECHNICAL FIELD

The present disclosure relates to an image processing apparatus, an imaging apparatus, an image processing method and a program. More particularly, the present disclosure relates to an image processing apparatus, an imaging apparatus, an image processing method and a program for measuring a distance to a subject.

### BACKGROUND ART

A time of flight (TOF) camera has been known as a camera which measures a distance to a subject.

The TOF camera irradiates the subject with infrared light and calculates the distance from the time required for the reflected infrared light to be incident on the camera.

Note that examples of the conventional technologies disclosed for the TOF system include Patent Document 1 (Japanese Patent Application Laid-Open No. 2013-220254), Patent Document 2 (Japanese Patent Application Laid-Open No. 2016-006627), and the like.

However, such a distance measuring system utilizing the infrared light has a problem that it is difficult to measure the distance, for example, outdoors where the sunlight is strong, and for a far subject which the irradiation infrared light does not reach.

### CITATION LIST

### Patent Document

Patent Document 1: Japanese Patent Application Laid-Open No. 2013-220254
Patent Document 2: Japanese Patent Application Laid-Open No. 2016-006627

### SUMMARY OF THE INVENTION

### Problems to be Solved by the Invention

The present disclosure has been made, for example, in light of the above problems, and an object of one example of the present disclosure is to provide an image processing apparatus, an imaging apparatus, an image processing method and a program for enabling accurate distance measurement even in a case where accurate distance measurement by the TOF system is difficult.

Moreover, an object of one example of the present disclosure is to provide an image processing apparatus, an imaging apparatus, an image processing method and a program for generating an image with high image quality to which a plurality of images are applied.

### Solutions to Problems

According to a first aspect of the present disclosure,

an image processing apparatus includes:

an image processing unit which inputs a first image and a second image, which are captured images from two different viewpoints, and generates distance information which indicates a subject distance,

in which the image processing unit includes:

a time of flight (TOF) system distance calculation unit which calculates a TOF distance, which is the subject distance according to a TOF system, by utilizing an infrared light component of the second image;

a stereo system distance calculation unit which calculates a stereo distance, which is the subject distance according to a stereo system, by utilizing the first image and a visible light component of the second image;

a TOF distance reliability determination unit which determines reliability of the TOF distance; and

a subject distance information generation unit which generates, as final distance information, the stereo distance or synthetic distance information of the TOF distance and the stereo distance, for a pixel region in which the reliability of the TOF distance is low.

Moreover, according to a second aspect of the present disclosure,

an imaging apparatus includes:

a first imaging unit which captures a first image constituted by a visible light component;

a second imaging unit which captures a second image including a visible light component and an infrared light component; and

an image processing unit which inputs the first image and the second image and generates distance information which indicates a subject distance,

in which the image processing unit includes:

a time of flight (TOF) system distance calculation unit which executes subject distance calculation according to a TOF system by utilizing the second image;

a stereo system distance calculation unit which executes subject distance calculation according to a stereo system by utilizing the first image and the second image;

a TOF distance reliability determination unit which determines reliability of a TOF distance which is the subject distance calculated by the TOF system distance calculation unit; and

a subject distance information generation unit which generates final distance information on the basis of the reliability of the TOF distance, and

the subject distance information generation unit generates, as the final distance information, the stereo distance, which is the subject distance according to the stereo system, or the distance information calculated by synthesis processing of the TOF distance and the stereo distance, for a pixel region in which the reliability of the TOF distance is low.

Furthermore, according to a third aspect of the present disclosure,

an image processing apparatus includes:

an image processing unit which inputs a first image and a second image, which are captured images from two different viewpoints, and generates a synthetic image,

in which the first image is an image constituted by a visible light component,

the second image is an image including a visible light component and an infrared light component, and

the image processing unit includes:

an infrared light separation unit which separates the second image into a visible light component image and an infrared light component image; and

an image synthesis unit which executes synthesis processing of the first image and the visible light component image generated on the basis of the second image by the infrared light separation unit.

Further, a fourth aspect of the present disclosure is an image processing method executed in an image processing apparatus,

in which the image processing apparatus includes:

an image processing unit which inputs a first image and a second image, which are captured images from two different viewpoints, and generates distance information which indicates a subject distance, and

the image processing unit executes:

time of flight (TOF) system distance calculation processing which calculates a TOF distance, which is the subject distance according to a TOF system, by utilizing an infrared light component of the second image;

stereo system distance calculation processing which calculates a stereo distance, which is the subject distance according to a stereo system, by utilizing the first image and a visible light component of the second image;

TOF distance reliability determination processing which determines reliability of the TOF distance; and

subject distance information generation processing which generates, as final distance information, the stereo distance or synthetic distance information of the TOF distance and the stereo distance, for a pixel region in which the reliability of the TOF distance is low.

Still further, a fifth aspect of the present disclosure is an image processing method executed in an image processing apparatus,

in which the image processing apparatus includes:

an image processing unit which inputs a first image and a second image, which are captured images from two different viewpoints, and generates a synthetic image,

the first image is an image constituted by a visible light component,

the second image is an image including a visible light component and an infrared light component, and

the image processing unit executes:

infrared light separation processing which separates the second image into a visible light component image and an infrared light component image; and

synthesis processing of the first image and the visible light component image generated on the basis of the second image.

Moreover, a sixth aspect of the present disclosure is a program for causing an image processing apparatus to execute image processing,

in which the image processing apparatus includes:

an image processing unit which inputs a first image and a second image, which are captured images from two different viewpoints, and generates distance information which indicates a subject distance, and

the program causes the image processing unit to execute:

time of flight (TOF) system distance calculation processing which calculates a TOF distance, which is the subject distance according to a TOF system, by utilizing an infrared light component of the second image;

stereo system distance calculation processing which calculates a stereo distance, which is the subject distance according to a stereo system, by utilizing the first image and a visible light component of the second image;

TOF distance reliability determination processing which determines reliability of the TOF distance; and

subject distance information generation processing which generates, as final distance information, the stereo distance or synthetic distance information of the TOF distance and the stereo distance, for a pixel region in which the reliability of the TOF distance is low.

Furthermore, a seventh aspect of the present disclosure is a program for causing an image processing apparatus to execute image processing,

in which the image processing apparatus includes:

an image processing unit which inputs a first image and a second image, which are captured images from two different viewpoints, and generates a synthetic image,

the first image is an image constituted by a visible light component,

the second image is an image including a visible light component and an infrared light component, and

the program causes the image processing unit to execute:

infrared light separation processing which separates the second image into a visible light component image and an infrared light component image; and

synthesis processing of the first image and the visible light component image generated on the basis of the second image.

Note that the program of the present disclosure is a program which is provided in a computer readable format and can be provided by a storage medium or a communication medium to, for example, an information processing apparatus or a computer system, which can execute various program codes. By providing such a program in a computer readable format, processings according to the program are realized on the information processing apparatus or the computer system.

Still other objects, features and advantages of the present disclosure will become apparent from a more detailed description based on the examples of the present disclosure described later and the accompanying drawings. Note that the term “system” in this specification refers to a logical group configuration of a plurality of apparatuses and is not limited to a system in which the apparatus of each configuration is in the same housing.

### Effects of the Invention

According to the configuration of one example of the present disclosure, an apparatus and a method for generating accurate distance information of a subject are realized.

Specifically, the apparatus has an image processing unit which inputs a first image constituted by a visible light component and a second image including a visible light component and an infrared light component to calculate a subject distance, in which the image processing unit calculates two distance information of a TOF distance, which is the subject distance calculated according to a TOF system by utilizing the second image, and a stereo distance calculated according to a stereo system by utilizing the first image and the second image, determines TOF distance reliability indicating reliability of the TOF distance, and generates, as final distance information, the stereo distance, which is the subject distance according to the stereo system, or distance information calculated by synthesis processing of the TOF distance and the stereo distance, for a pixel region in which the reliability of the TOF distance is low.

By these processings, the apparatus and the method for generating the accurate distance information of the subject are realized.

Note that the effects described in this specification are merely examples and are not limited, and other additional effects may be provided.

### BRIEF DESCRIPTION OF THE DRAWINGS

FIG. 1 is a diagram illustrating a configuration example of an image processing apparatus.

FIG. 2 is a diagram illustrating the configuration and processings of an image processing unit.

FIG. 3 is a diagram illustrating infrared light separation processing.

FIG. 4 is a diagram illustrating the processing of a stereo distance reliability determination unit.

FIG. 5 is a diagram illustrating the processing of a TOF distance reliability determination unit.

FIG. 6 is a diagram illustrating one example of the processing executed by a subject distance information generation unit.

FIG. 7 is a diagram illustrating one example of the processing executed by the subject distance information generation unit.

FIG. 8 is a diagram illustrating one example of the processing executed by the subject distance information generation unit.

FIG. 9 is a diagram illustrating one example of the processing executed by the subject distance information generation unit.

FIG. 10 is a diagram showing a flowchart for explaining the distance information generation processing sequence.

FIG. 11 is a diagram showing a flowchart for explaining the distance information generation processing sequence.

FIG. 12 is a diagram showing a flowchart for explaining the distance information generation processing sequence.

FIG. 13 is a diagram illustrating the configuration and processings of the image processing unit.

FIG. 14 is a diagram illustrating the configuration and processings of an image synthesis unit.

FIG. 15 is a diagram illustrating the processing executed by a blending execution unit.

FIG. 16 is a diagram for explaining the effects of blending processing.

FIG. 17 is a diagram showing a flowchart for explaining the synthetic image generation processing sequence.

### MODE FOR CARRYING OUT THE INVENTION

Hereinafter, details of an image processing apparatus, an imaging apparatus, an image processing method and a program of the present disclosure will be described with reference to the drawings. Note that the description is given according to the following items.

1. About Configuration and Processings of Image Processing Apparatus of Present Disclosure

2. About Configuration and Processings of Image Processing Unit Which Generates Distance (Depth) Information

3. About Distance Information Calculation Processing Sequence Executed by Image Processing Apparatus

3-1. About Processing Sequence Using Two Reliability Information of Stereo Distance Reliability and TOF Distance Reliability

3-2. About Processing Sequence Using One Reliability Information of Only TOF Distance Reliability

3-3. About Processing Sequence for Selecting One of Stereo Distance Information and TOF Distance Information in Pixel Unit as Final Distance Information by Using One Reliability Information of Only TOF Distance Reliability

4. About Configuration and Processings of Image Processing Unit Which Generates Synthetic Image with Improved Image Quality

5. About Synthetic Image Generation Processing Sequence Executed by Image Processing Apparatus

6. Summary of Configurations of Present Disclosure

[1. About Configuration and Processings of Image Processing Apparatus of Present Disclosure]

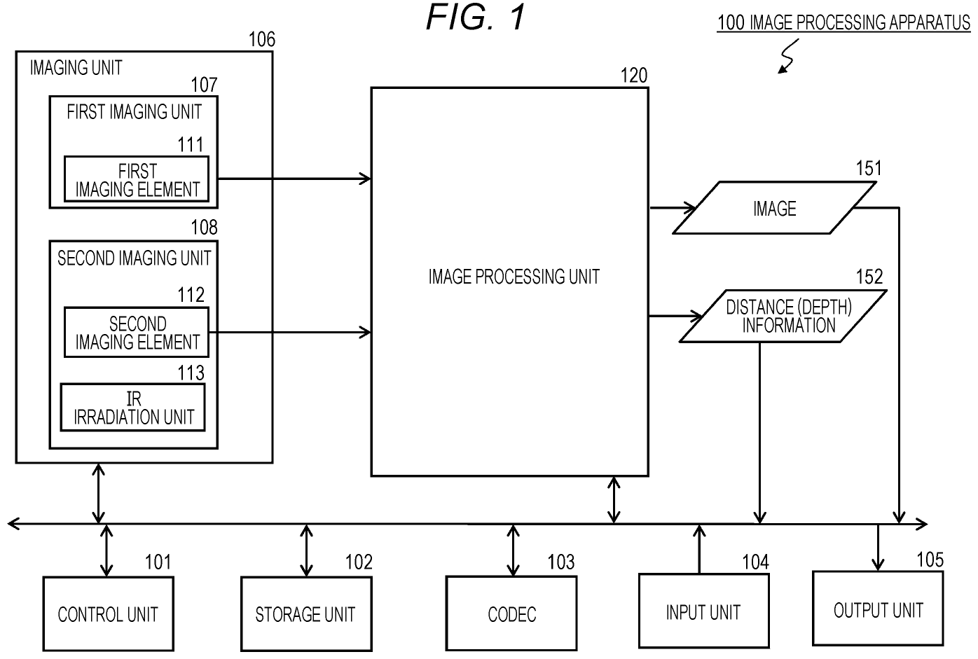

The configuration and processings of the image processing apparatus of the present disclosure will be described with reference to FIG. 1 and the followings.

FIG. 1 is a block diagram showing the configuration of an imaging apparatus, which is one example of an image processing apparatus 100 of the present disclosure.

Note that the image processing apparatus of the present disclosure is not limited to the imaging apparatus, but also includes, for example, an information processing apparatus, such as a PC, which inputs a captured image of the imaging apparatus and executes image processing.

In the following, the configuration and processings of the imaging apparatus will be described as one example of the image processing apparatus 100 of the present disclosure.

The image processings other than the capturing processing described in the following examples can be executed not only by the imaging apparatus, but also by an information processing apparatus such as a PC.

The image processing apparatus 100 as the imaging apparatus shown in FIG. 1 has a control unit 101, a storage unit 102, a codec 103, an input unit 104, an output unit 105, an imaging unit 106 and an image processing unit 120.

The imaging unit 106 has a first imaging unit 107 which performs only normal image capturing, and a second imaging unit 108 which performs infrared light irradiation and performs capturing of an image including infrared light and visible light.

The first imaging unit 107 has a first imaging element 111 for performing normal image capturing. The first imaging element 111 is, for example, an RGB pixel array type imaging element which has an RGB color filter constituted by a Bayer array and outputs a signal corresponding to input light of each color of R, G and B in each pixel unit. Alternatively, the first imaging element may be a white and black (WB) sensor type imaging element which captures a monochrome image.

The second imaging unit 108 has an infrared light (IR) irradiation unit 113 which outputs infrared light, and a second imaging element 112.

The second imaging unit 108 has the infrared light (IR) irradiation unit 113 for measuring a subject distance by a time of flight (TOF) system, and the second imaging element 112 which receives infrared light and visible light.

The time of flight (TOF) system is a system which irradiates the subject with the infrared light and calculates the subject distance from the time taken for the reflected infrared light to be incident on the camera.

Note that the visible light region received by the second imaging element 112 is preferably similar to a region of the first imaging element 111. For example, in a case where the first imaging element 111 is an RGB pixel array type imaging element, the second imaging element 112 is also an RGB pixel array type imaging element. In a case where the first imaging element 111 is a white and black (WB) sensor type imaging element, the second imaging element 112 is also a white and black (WB) sensor type imaging element.

However, the second imaging element 112 receives the visible light together with the infrared light (IR), and the sensor output includes a visible light component and an infrared light (IR) component.

The first imaging unit 107 and the second imaging unit 108 are two imaging units set at positions apart by a predetermined interval, and the respective captured images are images from different viewpoints.

The same subject image is not captured on the corresponding pixels, that is, the pixels at the same positions of the two images from the different viewpoints, and a subject shift according to a disparity occurs.

By utilizing this positional shift, the subject distance calculation by a stereo system is performed.

In a case where the captured image is a still image, the first imaging unit 107 and the second imaging unit 108 capture two still images at the same timing. In a case of capturing a moving image, the captured frame of each imaging unit is a synchronized captured frame, that is, a continuous image frame captured sequentially at the same timing.

Note that the control of these capturing timings is performed by the control unit 101.

The control unit 101 controls various processings executed in the imaging apparatus 100, such as image capturing, signal processing on a captured image, image recording processing, and display processing. The control unit 101 includes, for example, a CPU which executes processings according to various processing programs stored in the storage unit 102, and the like, and functions as a data processing unit which executes the programs.

The storage unit 102 is configured with a storage unit for captured images, further with a storage unit for the processing programs executed in the control unit 101 and various parameters, and still further with a RAM, a ROM and the like which function as working areas at the time of the data processing.

The codec 103 executes encoding and decoding processings such as compression and decompression processings of the captured images.

The input unit 104 is, for example, a user manipulation unit, and inputs control information such as start, end, and various mode settings for capturing.

The output unit 105 is configured with a display unit, a speaker and the like, and is utilized to display the captured images, a through image and the like, output sound, and the like.

The image processing unit 120 inputs the two images inputted from the imaging unit 106, applies these two images and calculates the subject distance (depth). Moreover, by synthesizing the two images, an image with high image quality in which noise is reduced is generated.

The image processing unit 120 outputs a generated image 151 and distance (depth) information 152.

These data are stored in, for example, the storage unit 102. Alternatively, the image 151 is outputted to the display unit configuring the output unit 105.

Furthermore, the distance (depth) information 152 is utilized for various processings executed in the control unit 102.

[2. About Configuration and Processings of Image Processing Unit which Generates Distance (Depth) Information]

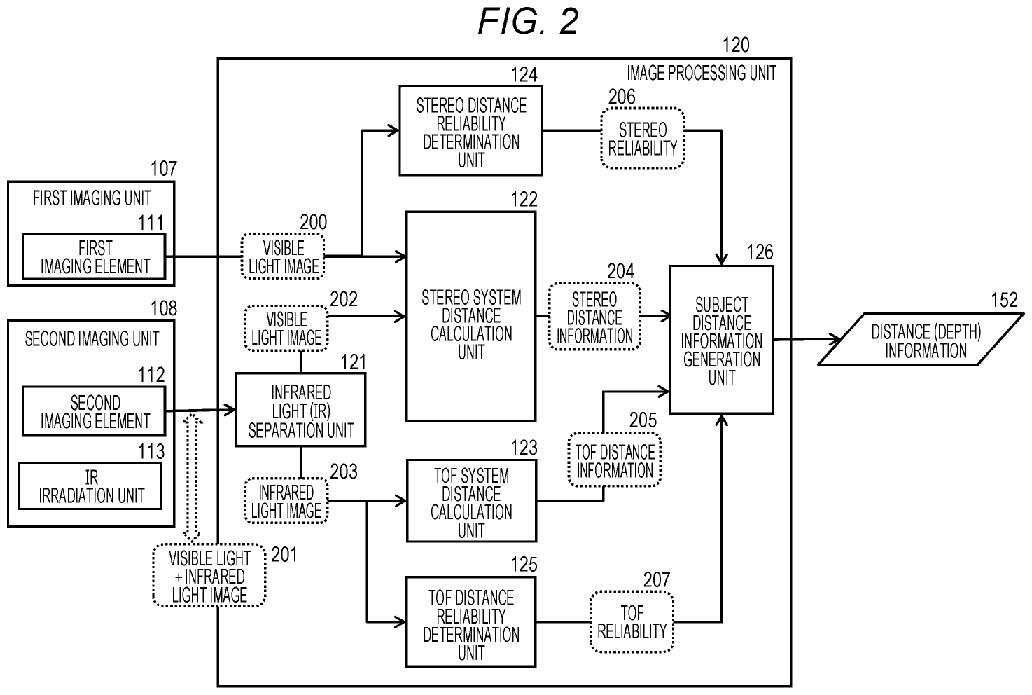

Next, the configuration and processings of the image processing unit 120 of the image processing apparatus 100 shown in FIG. 1 will be described with reference to FIG. 2 and the followings.

As previously mentioned, the image processing unit 120 inputs the two images inputted from the imaging unit 106, applies these two images and generates the distance (depth) information 152 indicating the subject distance (depth). Moreover, by synthesizing the two images, the image 151 as the image with high image quality in which noise is reduced is generated.

First, the generation processing of the distance (depth) information 152 executed in the image processing unit 120 will be described.

FIG. 2 is a block diagram showing the partial configuration of the image processing unit 120 of the image processing apparatus 100.

FIG. 2 shows a configuration applied to the generation processing of the distance (depth) information 152 among the configuration of the image processing unit 120.

As shown in FIG. 2, the image processing unit 120 has an infrared light (IR) separation unit 121, a stereo system distance calculation unit 122, a TOF system distance calculation unit 123, a stereo distance reliability determination unit 124, a TOF distance reliability determination unit 125 and a subject distance information generation unit 126.

The image processing unit 120 outputs the distance (depth) information 152 generated by the subject distance information generation unit 126.

The distance (depth) information 152 is data having distance information in each pixel unit for the subject included in the captured images.

The input signal into the image processing unit 120 is each of the following signals.

(1) A visible light image 200 inputted from the first imaging unit 107, and

(2) a visible light+infrared light image 201 inputted from the second imaging unit 108.

First, the infrared light (IR) separation unit 121 inputs the visible light+infrared light image 201 inputted from the second imaging unit 108 and executes infrared light (IR) separation processing on the visible light+infrared light image 201.

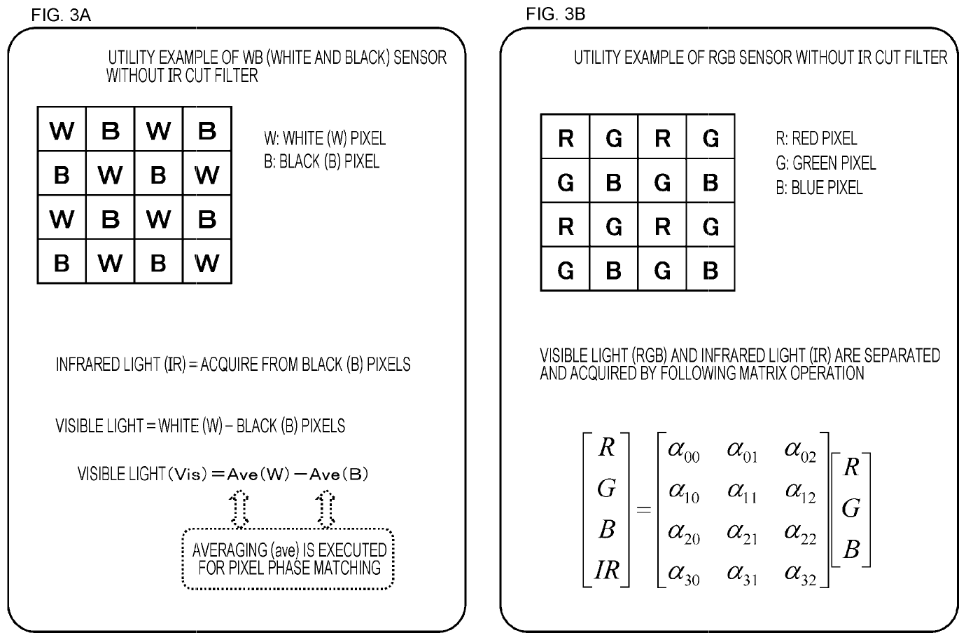

A specific example of the infrared light (IR) separation processing executed by the infrared light (IR) separation unit 121 will be described with reference to FIG. 3.

FIG. 3 is a diagram illustrating each of the infrared light separation processings in a case where the second imaging element 112 of the second imaging unit 108 has one of the following two configurations.

(1) Utility example of white and black (WB) sensor without IR cut filter

(2) Utility example of RGB sensor without IR cut filter

First, with reference to “(1) Utility example of white and black (WB) sensor without IR cut filter” in FIG. 3, the infrared light separation processing will be described in a case where the second imaging element 112 of the second imaging unit 108 is a white and black (WB) sensor without an IR cut filter.

In this case, the infrared light (IR) separation unit 121 performs the following processings on the output signal from the second imaging element 112 of the second imaging unit 108 to separate the visible light and the infrared light.

Infrared Light(IR)=Acquire From Black(B)Pixels

Visible Light=White(W)Pixel Output−Black(B)Pixel Output

However, it is preferable for the visible light that the average values (Ave) of the white (W) pixel output and the black (B) pixel output are calculated in a pixel region unit of a predetermined region unit for phase matching, and the difference between the average values are calculated as a visible light output signal. That is, the visible light image output is obtained according to the following expression.

Visible Light Image=Ave(White(W)Pixel Output)−Ave(Black(B)Pixel Output)

Next, with reference to “(2) Utility Example of RGB Sensor Without IR Cut Filter” shown in FIG. 3, the infrared light separation processing will be described in a case where the second imaging element 112 of the second imaging unit 108 is an RGB sensor without an IR cut filter.

In this case, the infrared light (IR) separation unit 121 executes matrix operation shown in the following (Expression 1) on the output signal from the second imaging element 112 of the second imaging unit 108 to separate the visible light and the infrared light.

$$\begin{matrix}[ Math . 1 ] & \\ [ \begin{matrix}R \\ G \\ B \\ I R\end{matrix} ] = [ \begin{matrix}{α}_{00} & {α}_{01} & {α}_{02} \\ {α}_{10} & {α}_{11} & {α}_{12} \\ {α}_{20} & {α}_{21} & {α}_{22} \\ {α}_{30} & {α}_{31} & {α}_{32}\end{matrix} ] [ \begin{matrix}R \\ G \\ B\end{matrix} ] & ( Expression 1 )\end{matrix}$$

In the above (Expression 1) , α₁₁ to α₃₂ are separation parameters decided according to sensor characteristics.

Thus, depending on whether the second imaging element 112 of the second imaging unit 108 is

(1) a white and black (WB) sensor without an IR cut filter, or

(2) an RGB sensor without an IR cut filter,

the infrared light (IR) separation unit 121 executes different processings described with reference to FIG. 3 to separate the visible light and the infrared light from the output signal, of the second imaging element 112 of the second imaging unit 108, that is, the “visible light+infrared light image 201” shown in FIG. 2.

As shown in FIG. 2, a visible light image 202 generated by the separation processing of the infrared light (IR) separation unit 121 is inputted into the stereo system distance calculation unit 122.

Furthermore, an infrared light image 203 generated by the separation processing of the infrared light (IR) separation unit 121 is inputted into a TOF system distance calculation unit 123.

Next, the processing of the stereo system distance calculation unit 122 will be described.

The stereo system distance calculation unit 122 inputs the following images.

(1) The visible light image 200 which is the captured image of the first imaging unit 107, and

(2) the visible light image 202 generated from the captured image of the second imaging unit 108.

As previously mentioned, the first imaging unit 107 and the second imaging unit 108 are two imaging units set at positions apart by a predetermined interval, and the respective captured images (the visible light image 200 and the visible light image 202) are images from different viewpoints.

The same subject image is not captured on the corresponding pixels, that is, the pixels at the same positions of the two images from the different viewpoints, that is, the visible light image 200 and the visible light image 202, and a subject shift according to a disparity occurs.

The stereo system distance calculation unit 122 utilizes this positional shift to execute the subject distance calculation by the stereo system.

Specifically, first, the disparity amount is calculated by using two image signals of the visible light image 200 inputted from the first imaging unit 107 and the visible light image 202 inputted from the second imaging unit 108. Moreover, the distance to the subject is calculated by triangulation on the basis of the baseline length, which is the interval between the first imaging unit 107 and the second imaging unit 108, and the disparity amount.

Note that this distance calculation is executed in pixel units constituting the image or pixel region units including a plurality of pixels.

Subject distance information generated by the stereo system distance calculation unit 122 is inputted as stereo distance information 204 into the subject distance information generation unit 126 as shown in FIG. 2.

Next, the processing of the TOF system distance calculation unit 123 will be described.

The TOF system distance calculation unit 123 inputs the following image.

(1) The infrared light (IR) image 203 generated from the captured image of the second imaging unit 108.

As previously mentioned, the time of flight (TOF) system is a system which irradiates the subject with the infrared light and calculates the subject distance from the time taken for the reflected infrared light to be incident on the camera.

The TOF system distance calculation unit 123 measures the time from the infrared light irradiation timing of the infrared light (IR) irradiation unit 113 of the second imaging unit 108 to the infrared light reception timing of the second imaging element 112 and calculates the subject distance.

Note that this subject distance calculation is also executed in pixel units or pixel region units including a predetermined number of pixels, similarly to the stereo system previously mentioned.

However, such a distance measuring system utilizing the infrared light has a problem that it is difficult to measure the distance, for example, outdoors where the sunlight is strong, and for a far subject which the irradiation infrared light does not reach.

Subject distance information generated by the TOF system distance calculation unit 123 is inputted as TOF distance information 205 into the subject distance information generation unit 126 as shown in FIG. 2.

Next, the processing executed by the stereo distance reliability determination unit 124 will be described.

The stereo distance reliability determination unit 124 determines whether or not the subject distance information generated by the stereo system distance calculation unit 122 is reliable data, generates stereo reliability 206 including the determination information, and outputs the stereo reliability 206 to the subject distance information generation unit 126 as shown in FIG. 2.

Note that the stereo reliability 206 generated by the stereo distance reliability determination unit 124 includes reliability information for each of the subject distance information in pixel units or pixel region units generated by the stereo system distance calculation unit 122.

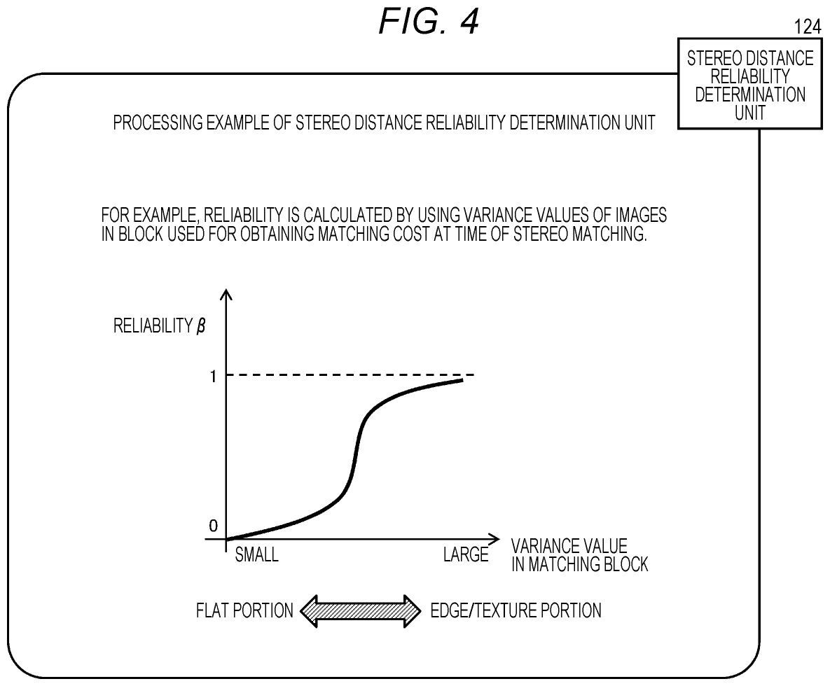

A specific example of the reliability determination processing executed by the stereo distance reliability determination unit 124 will be described with reference to FIG. 4.

The example shown in FIG. 4 is processing of determining the reliability by using variance values of block configuration pixels applied to block matching processing in detection of the corresponding points of the two images executed in the stereo system distance calculation unit 122.

In the stereo system distance calculation unit 122, for the images captured from two different viewpoints, that is,

(1) the visible light image 200 which is the captured image of the first imaging unit 107, and

(2) the visible light image 202 generated from the captured image of the second imaging unit 108,

so-called block matching processing of detecting corresponding pixel blocks between these images, that is, pixel blocks assumed to have captured the same subject, is executed.

In this block matching, when a characteristic image such as an edge and a texture is included in the utilized pixel block, matching (association) can be correctly performed. That is, highly precise block matching becomes possible, and highly precise distance calculation becomes possible. On the other hand, it is difficult to perform correct matching (association) for, for example, a flat image region without a characteristic, such as sky. As a result, highly precise distance calculation becomes difficult.

The example shown in FIG. 4 is an example of the reliability determination processing of the stereo distance utilizing this characteristic.

In the graph shown in FIG. 4, the horizontal axis is the variance value of the block configuration pixel applied to the block matching processing, and the vertical axis is the reliability β of the stereo distance.

Note that the reliability β of the stereo distance is set in the range from zero to one, and the lower the numerical value the lower the reliability, the higher the numerical value the higher the reliability.

A case where the variance value of the block is large means that many characteristic images, for example, images of edge portions, textures and the like are included in the block, which means that this block is a characteristic block which enhances the precision of the block matching.

In such a case where the variance value of the block is large, the reliability β of the stereo distance calculated by the stereo system distance calculation unit 122 is a higher value, that is, a value close to one.

On the other hand, a case where the variance value of the block is small means that the block has a few images of the edge portions, textures and the like and is constituted by a flat image with a small change in the pixel value, for example, of sky or the like, which means this block is a block which lowers the precision of the block matching.

In such a case where the variance value of the block is small, the reliability β of the stereo distance calculated by the stereo system distance calculation unit 122 is a lower value, that is, a value close to zero.

The stereo distance reliability determination unit 124 executes the reliability β of the stereo distance calculated by the stereo system distance calculation unit 122, for example, in block units and generates the distance information reliability in block units or block configuration pixel units.

This reliability information is the stereo reliability 206 shown in FIG. 2.

The stereo distance reliability determination unit 124 outputs the generated stereo reliability 206 to the subject distance information generation unit 126 as shown in FIG. 2.

Next, the processing executed by the TOF distance reliability determination unit 125 will be described.

The TOF distance reliability determination unit 125 determines whether or not the subject distance information generated by the TOF system distance calculation unit 123 is reliable data, generates TOF reliability 207 including the determination information, and outputs the TOF reliability 207 to the subject distance information generation unit 126 as shown in FIG. 2.

Note that the TOF reliability 206 generated by the TOF distance reliability determination unit 125 includes reliability information for each of the subject distance information in pixel units or pixel region units generated by the TOF system distance calculation unit 123.

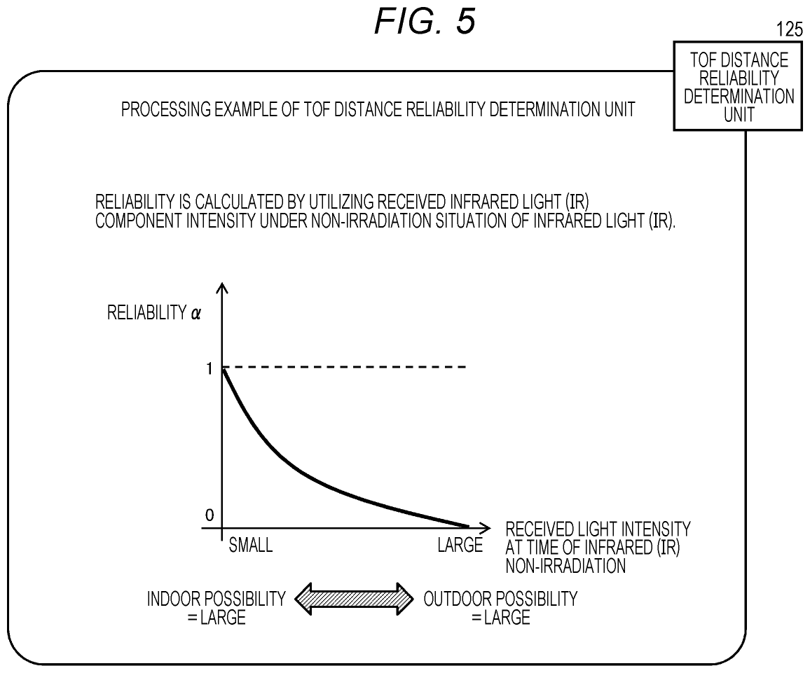

A specific example of the reliability determination processing executed by the TOF distance reliability determination unit 125 will be described with reference to FIG. 5.

The example shown in FIG. 5 is processing of determining the reliability by using the amount of the received light at a time of non-irradiation of the infrared light (IR) utilized for the distance measurement according to the TOF system executed in the TOF system distance calculation unit 123.

As previously mentioned, in the TOF system distance calculation unit 123, the time from the infrared light irradiation timing of the infrared light (IR) irradiation unit 113 of the second imaging unit 108 to the infrared light reception timing of the second imaging element 112 is measured, and the subject distance is calculated.

However, infrared light also exists in nature, and sunlight in particular includes many infrared light components.

The second imaging element 112 of the second imaging unit 108 receives not only the infrared light by the irradiation of the infrared light (IR) irradiation unit 113, but also such infrared light other than the irradiation light of the infrared light (IR) irradiation unit 113.

For example, in a case where an image is captured under sunlight including infrared light components, such as outdoors on a sunny day, the second imaging element 112 receives a lot of the infrared light in nature other than the infrared light by the irradiation of the infrared light (IR) irradiation unit 113. In such a situation, the measurement precision of the time from the infrared light irradiation timing of the infrared light (IR) irradiation unit 113 to the infrared light reception timing of the second imaging element 112 lowers. As a result, highly precise distance calculation becomes difficult.

On the other hand, for example, in a case where an image is captured in an environment, such as at night or indoors, where there is little influence of sunlight including infrared light components, the possibility that second imaging element 112 receives the infrared light other than the illumination light of the infrared light (IR) irradiation unit 113 is reduced. As a result, the measurement precision of the time from the infrared light irradiation timing of the infrared light (IR) irradiation unit 113 to the infrared light reception timing of the second imaging element 112 is enhanced, enabling highly precise distance calculation.

The example shown in FIG. 5 is an example of the reliability determination processing of the TOF distance utilizing this characteristic.

In the graph shown in FIG. 5, the horizontal axis is the received light intensity of the infrared light (IR) by the second imaging element 112 at a time of non-irradiation of the infrared light by the infrared light (IR) irradiation unit 113, and the vertical axis is the reliability α of the TOF distance.

Note that the reliability α of the TOF distance is set in the range from zero to one, and the lower the numerical value the lower the reliability, the higher the numerical value the higher the reliability.

A case where the received light intensity of the infrared light is large at a time of non-irradiation of the infrared light by the infrared light (IR) irradiation unit 113 means that there are a lot of infrared light of external factors such as sunlight, which means that it is difficult to measure the TOF distance accurately.

In such a case where the received light intensity is large at the time of non-irradiation of the infrared light by the infrared light (IR) irradiation unit 113, the reliability α of the TOF distance calculated by the TOF system distance calculation unit 123 is a lower value, that is, a value close to zero.

On the other hand, a case where the received light intensity is small at the time of non-irradiation of the infrared light by the infrared light (IR) irradiation unit 113 means that there is a little infrared light of external factors such as sunlight, which means that it is possible to measure the TOF distance accurately.

In such a case where the received light intensity is small at the time of non-irradiation of the infrared light by the infrared light (IR) irradiation unit 113, the reliability α of the TOF distance calculated by the TOF system distance calculation unit 123 is a higher value, that is, a value close to one.

The TOF distance reliability determination unit 125 calculates the reliability α of the TOF distance calculated by the TOF system distance calculation unit 123, for example, in pixel units or pixel region units.

This reliability information is the TOF reliability 207 shown in FIG. 2.

The TOF distance reliability determination unit 125 outputs the generated TOF reliability 207 to the subject distance information generation unit 126 as shown in FIG. 2.

Next, the subject distance information generation processing executed by the subject distance information generation unit 126 will be described.

As shown in FIG. 2, the subject distance information generation unit 126 inputs each of the following data.

(1) The stereo distance information 204 calculated by the stereo system distance calculation unit 122,

(2) the TOF distance information 205 calculated by the TOF system distance calculation unit 123,

(3) the stereo reliability 206 generated by the stereo distance reliability determination unit 124, and

(4) the TOF reliability 207 generated by the TOF distance reliability determination unit 125.

The subject distance information generation unit 126 inputs each of these data, generates the final distance information which is one of the stereo distance information 204 calculated by the stereo system distance calculation unit 122 and the TOF distance information 205 calculated by the TOF system distance calculation unit 123 or is generated by blending processing, and outputs the final distance information as the distance (depth) information 152.

Note that, on the basis of the stereo reliability 206 and the TOF reliability 207, the subject distance information generation unit 126 generates the final distance information which is one of the distance information determined to have high reliability or is generated by the blending processing, and outputs the final distance information as the distance (depth) information 152.

Note that the generation of the final distance information based on these reliability determinations is executed in pixel units or pixel region units.

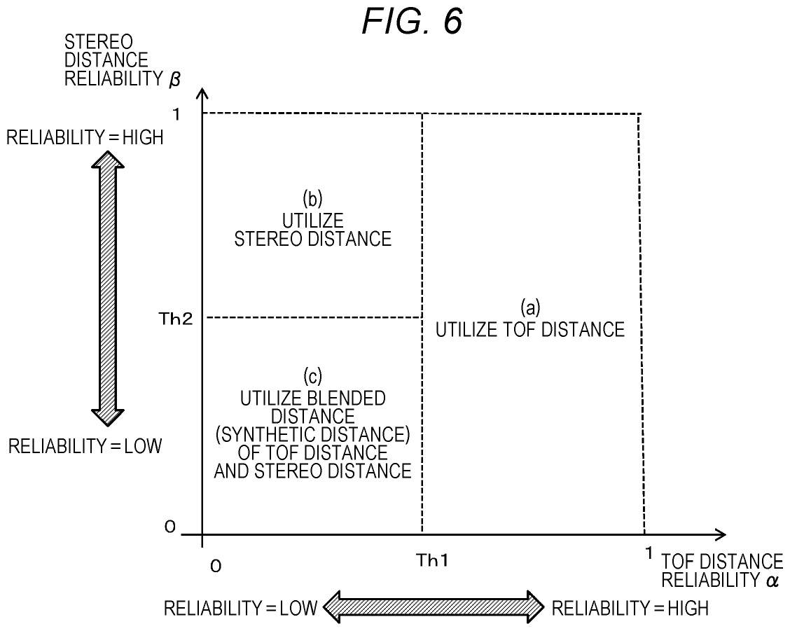

A specific processing example executed by the subject distance information generation unit 126 will be described with reference to FIG. 6 and the followings.

As described above, on the basis of the stereo reliability 206 and the TOF reliability 207, the subject distance information generation unit 126 selects one of the distance information with high reliability or generates the final distance information by the blending processing, and outputs the information as the distance (depth) information 152.

The example shown in FIG. 6 is a processing example in which the TOF distance information 205 calculated by the TOF system distance calculation unit 123 is set to be preferentially selected.

In the graph shown in FIG. 6,

the horizontal axis is the TOF reliability α generated by the TOF distance reliability determination unit 125, and

the vertical axis is the stereo reliability β generated by the stereo distance reliability determination unit 124.

Both of the reliabilities α and β are values in the range from zero to one, the lowest reliability is zero, and the highest reliability is one.

The graph shown in FIG. 6 is divided into three regions of (a), (b) and (c).

The region (a) is a region meeting the following conditions of:

TOF reliability α≥Th1, and

Stereo reliability β=0 to 1.

Note that Th1 is a reliability threshold value, and, for example, Th1=0.5.

The region (b) is a region meeting the following conditions of:

TOF reliability α<Th1, and

Stereo reliability β≥Th2.

Note that Th2 is also a reliability threshold value, and, for example, Th2=0.5.

The region (c) is a region meeting the following conditions of:

TOF reliability α<Th1, and

Stereo reliability β<Th2.

The subject distance information generation unit 126 determines which region (a) to (c) that the two reliabilities,

(1) the stereo reliability β generated by the stereo distance reliability determination unit 124, and

(2) the TOF reliability α generated by the TOF distance reliability determination unit 125,

belong and generates the final distance information, that is, the distance (depth) information 152, which is the output of the subject distance information generation unit 126 shown in FIG. 2, according to each region as the following.

The region (a), that is, the region meeting the following conditions of:

TOF reliability α≥Th1, and

Stereo reliability β=0 to 1

is a region determined that the TOF reliability α is relatively high.

The subject distance information generation unit 126 sets, as the final distance information, that is, the configuration data of the distance (depth) information 152 shown in FIG. 2, the TOF distance information 205 calculated by the TOF system distance calculation unit 123 for the pixel or the pixel region corresponding to this region.

The region (b), that is, the region meeting the following conditions of:

TOF reliability α<Th1, and

Stereo reliability β≥Th2

is a region determined that the TOF reliability α is relatively low and the stereo reliability β is relatively high.

The subject distance information generation unit 126 sets, as the final distance information, that is, the configuration data of the distance (depth) information 152 shown in FIG. 2, the stereo distance information 204 calculated by the stereo system distance calculation unit 122 for the pixel or the pixel region corresponding to this region.

The region (c), that is, the region meeting the following conditions of:

TOF reliability α<Th1, and

Stereo reliability β<Th2

is a region determined that the TOF reliability α is relatively low and the stereo reliability β is also relatively low.

The subject distance information generation unit 126 sets, as the final distance information, that is, the configuration data of the distance (depth) information 152 shown in FIG. 2, the blending (synthesizing) processing result of the TOF distance information 205 calculated by the TOF system distance calculation unit 123 and the stereo distance information 204 calculated by the stereo system distance calculation unit 122 for the pixel or the pixel region corresponding to this region.

Note that a specific example of the blending (synthesizing) processing will be described later.

The processing example shown in FIG. 6 is a processing example in which the TOF distance information 205 calculated by the TOF system distance calculation unit 123 is set to be preferentially selected.

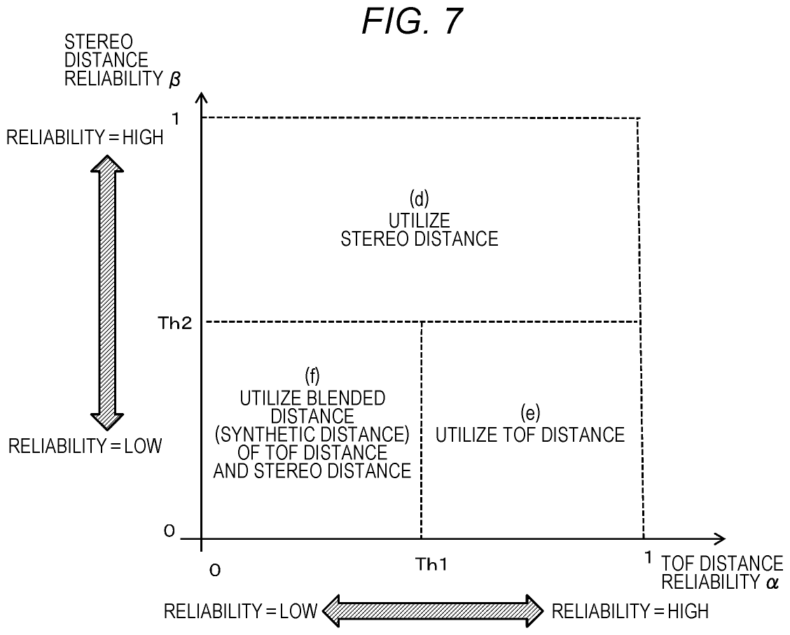

Next, with reference to FIG. 7, a processing example, in which the stereo distance information 204 calculated by the stereo system distance calculation unit 122 is set to be preferentially selected, will be described.

Like the graph shown in FIG. 6, in the graph shown in FIG. 7,

the horizontal axis is the TOF reliability α generated by the TOF distance reliability determination unit 125, and

the vertical axis is the stereo reliability β generated by the stereo distance reliability determination unit 124.

Both of the reliabilities α and β are values in the range from zero to one, the lowest reliability is zero, and the highest reliability is one.

The graph shown in FIG. 7 is divided into three regions of (d) , (e) and (f).

The region (d) is a region meeting the following conditions of:

Stereo reliability β≥Th2, and

TOF reliability α=0 to 1.

Note that Th2 is a reliability threshold value, and, for example, Th2=0.5.

The region (e) is a region meeting the following conditions of:

Stereo reliability β<Th2, and

TOF reliability α≥Th1.

Note that Th1 is also a reliability threshold value, and, for example, Th1=0.5.

The region (f) is a region meeting the following conditions of:

Stereo reliability β<Th2, and

TOF reliability α<Th1.

The subject distance information generation unit 126 determines which region (d) to (f) that the two reliabilities,

(1) the stereo reliability β generated by the stereo distance reliability determination unit 124, and

(2) the TOF reliability α generated by the TOF distance reliability determination unit 125,

belong and generates the final distance information, that is, the distance (depth) information 152, which is the output of the subject distance information generation unit 126 shown in FIG. 2, according to each region as the following.

The region (d), that is, the region meeting the following conditions of:

Stereo reliability β≥Th2, and

TOF reliability α=0 to 1

is a region determined that the stereo reliability β is relatively high.

The subject distance information generation unit 126 sets, as the final distance information, that is, the configuration data of the distance (depth) information 152 shown in FIG. 2, the stereo distance information 204 calculated by the stereo system distance calculation unit 122 for the pixel or the pixel region corresponding to this region.

The region (e), that is, the region meeting the following conditions of:

Stereo reliability β<Th2, and

TOF reliability α≥Th1

is a region determined that the stereo reliability β is relatively low and the TOF reliability α is relatively high.

The subject distance information generation unit 126 sets, as the final distance information, that is, the configuration data of the distance (depth) information 152 shown in FIG. 2, the TOF distance information 205 calculated by the TOF system distance calculation unit 123 for the pixel or the pixel region corresponding to this region.

The region (f), that is, the region meeting the following conditions of:

Stereo reliability β<Th2, and

TOF reliability α<Th1

is a region determined that the stereo reliability β is relatively low and the TOF reliability α is also relatively low.

The subject distance information generation unit 126 sets, as the final distance information, that is, the configuration data of the distance (depth) information 152 shown in FIG. 2, the blending (synthesizing) processing result of the TOF distance information 205 calculated by the TOF system distance calculation unit 123 and the stereo distance information 204 calculated by the stereo system distance calculation unit 122 for the pixel or the pixel region corresponding to this region.

Note that a specific example of the blending (synthesizing) processing will be described later.

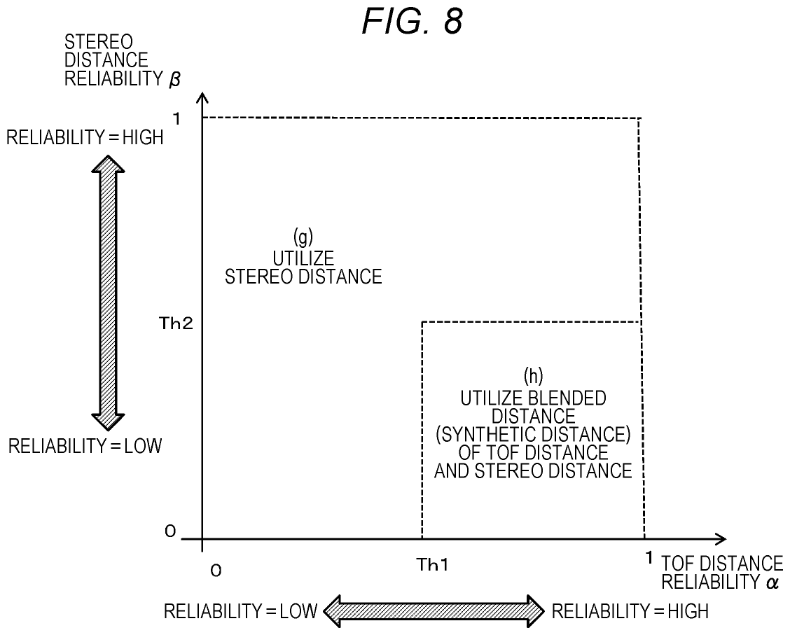

Moreover, with reference to FIG. 8, still another processing example, in which the stereo distance information 204 calculated by the stereo system distance calculation unit 122 is set to be preferentially selected, will be described.

Like the graph shown in FIG. 6, in the graph shown in FIG. 8,

the horizontal axis is the TOF reliability α generated by the TOF distance reliability determination unit 125, and

the vertical axis is the stereo reliability β generated by the stereo distance reliability determination unit 124.

Both of the reliabilities α and β are values in the range from zero to one, the lowest reliability is zero, and the highest reliability is one.

The graph shown in FIG. 8 is divided into two regions of (g) and (h).

The region (g) is a region meeting one of the following conditions of:

Stereo reliability β≥Th2, and

TOF reliability α=0 to 1,

and,

Stereo reliability β<Th2, and

TOF reliability α<Th1.

Note that Th1 and Th2 are reliability threshold values, and, for example, Th1=0.5 and Th2=0.5.

The region (h) is a region meeting the following conditions of:

Stereo reliability β<Th2, and

TOF reliability α≥Th1.

The subject distance information generation unit 126 determines which region (g) or (h) that the two reliabilities,

(1) the stereo reliability β generated by the stereo distance reliability determination unit 124, and

(2) the TOF reliability α generated by the TOF distance reliability determination unit 125,

belong and generates the final distance information, that is, the distance (depth) information 152, which is the output of the subject distance information generation unit 126 shown in FIG. 2, according to each region as the following.

The region (g), that is, the region meeting one of the following conditions of:

Stereo reliability β≥Th2, and

TOF reliability α=0 to 1,

and,

Stereo reliability β<Th2, and

TOF reliability α<Th1,

is one of regions of a region in which the stereo reliability β is relatively high and a region in which both the stereo reliability β and the TOF reliability α are relatively low.

The subject distance information generation unit 126 sets, as the final distance information, that is, the configuration data of the distance (depth) information 152 shown in FIG. 2, the stereo distance information 204 calculated by the stereo system distance calculation unit 122 for the pixel or the pixel region corresponding to this region.

The region (h), that is, the region meeting the following conditions of:

Stereo reliability β<Th2, and

TOF reliability α≥Th1

is a region determined that the stereo reliability β is relatively low and the TOF reliability α is relatively high.

The subject distance information generation unit 126 sets, as the final distance information, that is, the configuration data of the distance (depth) information 152 shown in FIG. 2, the blending (synthesizing) processing result of the TOF distance information 205 calculated by the TOF system distance calculation unit 123 and the stereo distance information 204 calculated by the stereo system distance calculation unit 122 for the pixel or the pixel region corresponding to this region.

Note that a specific example of the blending (synthesizing) processing will be described later.

As described with reference to FIGS. 6, 7 and 8, the subject distance information generation unit 126 determines which predefined reliability section region that the two reliabilities,

(1) the stereo reliability β generated by the stereo distance reliability determination unit 124, and

(2) the TOF reliability α generated by the TOF distance reliability determination unit 125,

belong and generates the final distance information, that is, the distance (depth) information 152, which is the output of the subject distance information generation unit 126 shown in FIG. 2, according to each region as the following.

A specific example of the blending (synthesizing) processing of the two distance information executed by the subject distance information generation unit 126 will be described.

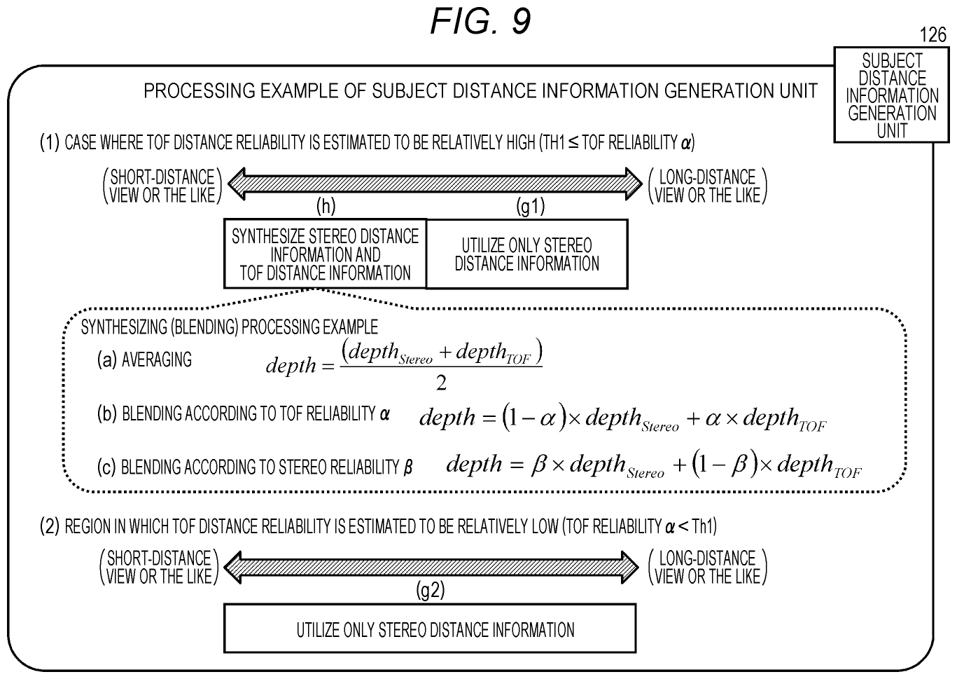

FIG. 9 shows a processing example of the subject distance information generation unit 126 similar to the processing example described with reference to FIG. 8.

FIG. 9(1) shows a processing example of a case where the TOF distance reliability is estimated to be relatively high (Th1≤TOF reliability α).

This corresponds to the right half region (Th1≤TOF reliability α) of the graph in FIG. 8.

FIG. 9(h) corresponds to the region in FIG. 8(h), performs the blending processing of the stereo distance information and the TOF distance information, and sets the blending (synthesizing) processing result as the final distance information.

FIG. 9(g1) corresponds to the right side region (Th1≤TOF reliability α) in FIG. 8(g)

In this region, since the stereo reliability β of the stereo distance information is sufficiently high, the stereo distance information is set as the final distance information.

FIG. 9(2) shows a processing example of a case where the TOF distance reliability is estimated to be relatively low (TOF reliability α<Th1).

This corresponds to the left half region (TOF reliability α<Th1) of the graph in FIG. 8.

FIG. 9(g2) corresponds to the left side region (TOF reliability α<Th1) in FIG. 8(g).

In this region, since the TOF reliability α of the TOF distance information is low, the stereo distance information is set as the final distance information.

FIG. 9(1) shows a specific processing example of the blending processing of the stereo distance information and the TOF distance information.

Various processings are possible for the blending processing of the stereo distance information and the TOF distance information.

The following three blending processing examples will be described.

(a) Blending processing by averaging

(b) Blending processing in which the TOF reliability α is applied as a blending ratio setting parameter

(c) Blending processing in which the stereo reliability β is applied as a blending ratio setting parameter

The final distance information [depth] by these three types of blending processings is calculated by the following (Expression 2a) to (Expression 2c) when

the stereo distance information 204 generated by the stereo system distance calculation unit 122 is “depthₛₜₑᵣₑₒ,” and

the TOF distance information 205 generated by the TOF system distance calculation unit 123 is [depth_{TOF}].

$$\begin{matrix}[ Math . 2 ] & \\ ( a ) Average value \\ depth = \frac{( {depth}_{Stereo} + {depth}_{TOF}}{2} & ( Expression 2 a ) \\ ( b ) Blending according to TOF reliability α \\ depth = ( 1 - α ) \times {depth}_{Stereo} + α \times {depth}_{TOF} & ( Expression 2 b ) \\ ( c ) Blending according to stereo reliability β \\ depth = β \times {depth}_{Stereo} + ( 1 - β ) \times {depth}_{TOF} & ( Expression 2 c )\end{matrix}$$

Note that the above (Expression 2a) to (Expression 2c) are one example of the blending processing of the distance information, and the blending processing according to other various aspects can be applied.

[3. About Distance Information Calculation Processing Sequence Executed by Image Processing Apparatus]

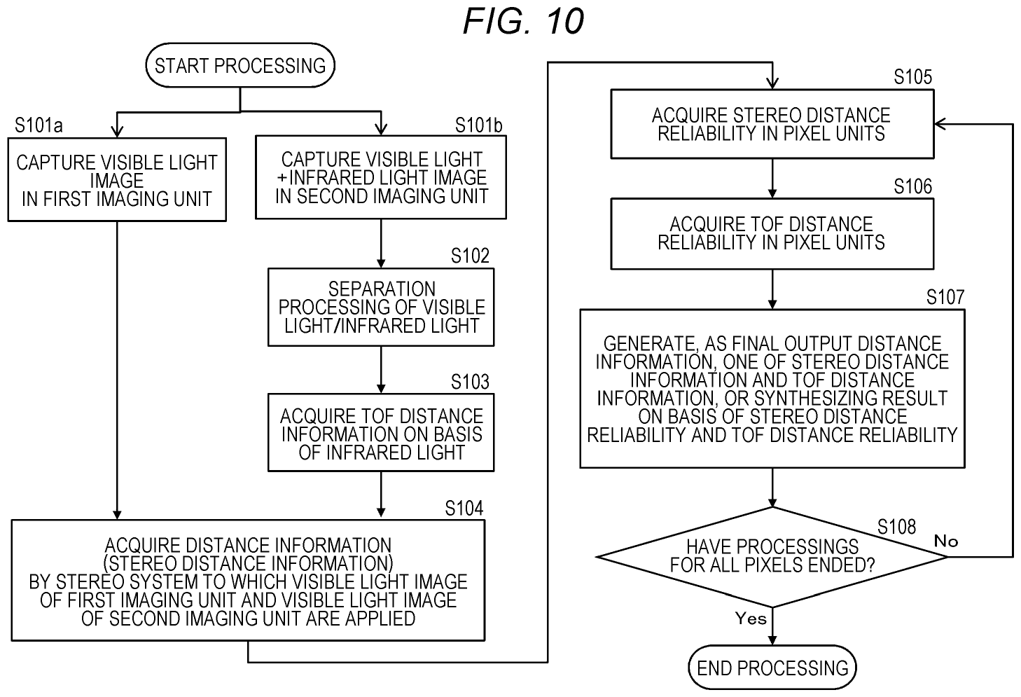

Next, the distance information calculation processing sequence executed by the image processing apparatus will be described with reference to the flowcharts in FIG. 10 and the followings.

The flowcharts shown in FIGS. 10 to 12 are flowcharts for explaining three different kinds of distance information calculation processing sequences executed by the image processing apparatus 100.

Specifically, the flowcharts correspond to the distance information calculation processing sequences of the following aspects, respectively.

(1) A processing sequence using two reliability information of the stereo distance reliability and the TOF distance reliability (FIG. 10)

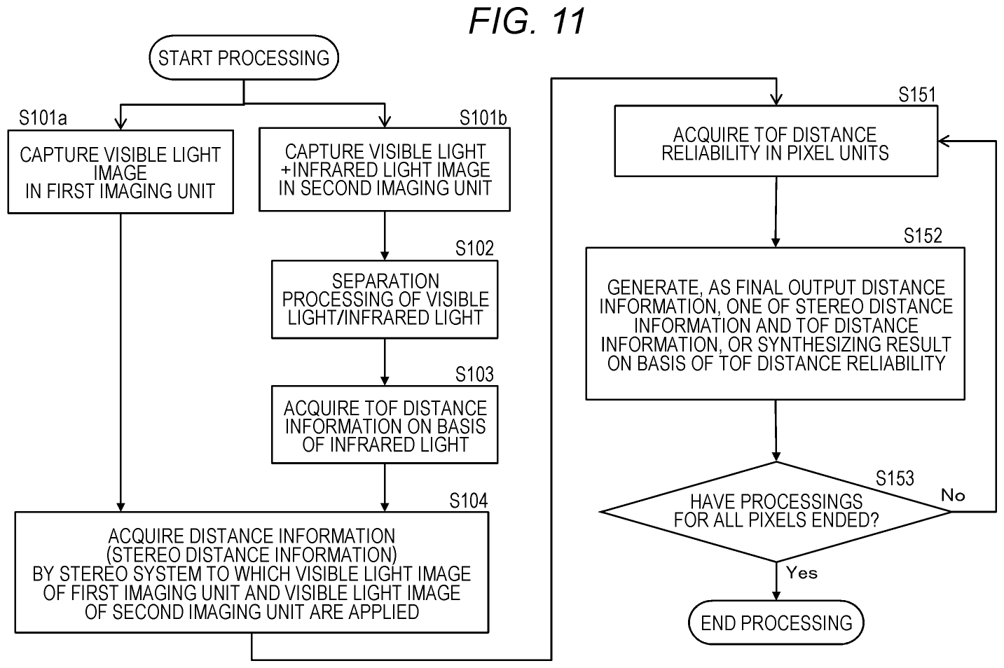

(2) A processing sequence using one reliability information of only the TOF distance reliability (FIG. 11)

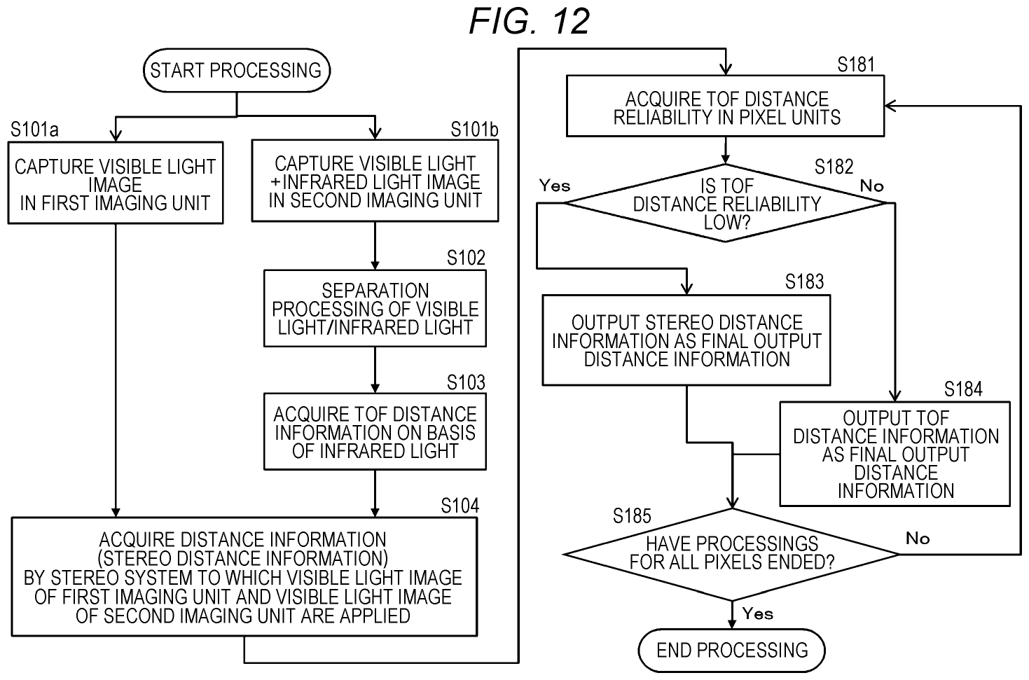

(3) A processing sequence for selecting one of the stereo distance information and the TOF distance information in pixel units as the final distance information by using one reliability information of only the TOF distance reliability (FIG. 12)

Note that the flowcharts shown in FIG. 10 and the followings are executed, for example, under the control of the control unit (data processing unit) including a CPU which executes processings according to the processing programs stored in the storage unit, and the like.

Hereinafter, the processing in each step of the flowchart shown in FIG. 10 will be sequentially described.

[3-1. About Processing Sequence Using Two Reliability Information of Stereo Distance Reliability and TOF Distance Reliability]

First, with reference to the flowchart shown in FIG. 10, the processing sequence using two reliability information of the stereo distance reliability and the TOF distance reliability will be described.

Hereinafter, the processing in each step will be sequentially described.

(Steps S101a and S101b)

Steps S101a and S101b are image capturing processings.

The two images are captured in the first imaging unit 107 and the second imaging unit 108 shown in FIGS. 1 and 2.

Step S101a is the capturing processing of the visible light image 200 in the first imaging unit 107 shown in FIG. 2.

Step S101b is the capturing processing of the visible light+infrared light image 201 in the second imaging unit 108 shown in FIG. 2.

(Step S102)

Step S102 is the processing executed by the infrared light (IR) separation unit 121 shown in FIG. 2.

In Step S102, the infrared light (IR) separation unit 121 inputs the visible light+infrared light image 201 captured by the second imaging unit 108 in Step S101b, executes the infrared light (IR) separation processing, and generates the visible light image 202 and the infrared light image 203 shown in FIG. 2.

This infrared light (IR) separation processing is the processing previously described with reference to FIG. 3.

(Step S103)

The processing in the next Step S103 is the processing executed by the TOF system distance calculation unit 123 shown in FIG. 2.

In Step S103, the TOF system distance calculation unit 123 executes the subject distance calculation processing according to the time of flight (TOF) system.

The TOF system distance calculation unit 123 utilizes the infrared light image 203 generated by the infrared light (IR) separation unit 121 in Step S102 to measure the time from the infrared light irradiation timing of the infrared light (IR) irradiation unit 113 of the second imaging unit 108 shown in FIG. 2 to the infrared light reception timing of the second imaging element 112, and calculates the subject distance.

Note that this subject distance calculation is executed in pixel units or pixel region units including a predetermined number of pixels.

(Step S104)

The processing in the next Step S104 is the processing executed by the stereo system distance calculation unit 122 shown in FIG. 2.

In Step S104, the stereo system distance calculation unit 122 executes the subject distance calculation processing according to the stereo system.

Specifically, the distance to the subject is calculated by triangulation based on the disparity amount calculated by using the two image signals of the visible light image 200 captured by the first imaging unit 107 in Step S101a and the visible light image 202 captured by the second imaging unit 108 in Step S101b and generated in Step S102, and the baseline length which is the interval between the first imaging unit 107 and the second imaging unit 108.

Note that this distance calculation is executed in pixel units constituting the image or pixel region units including a plurality of pixels.

(Step S105)

The processing in the next Step S105 is the processing executed by the stereo distance reliability determination unit 124 shown in FIG. 2.

In Step S105, the stereo distance reliability determination unit 124 determines whether or not the subject distance information generated by the stereo system distance calculation unit 122 is reliable data, generates the stereo reliability 206 including the determination information, and outputs the stereo reliability 206 to the subject distance information generation unit 126 as shown in FIG. 2.

Note that the stereo reliability 206 generated by the stereo distance reliability determination unit 124 includes reliability information for each of the subject distance information in pixel units or pixel region units generated by the stereo system distance calculation unit 122.

As previously described with reference to FIG. 4, for example, the stereo distance reliability determination unit 124 determines the reliability by using the variance values of the block configuration pixels applied to the block matching processing in the stereo system distance calculation unit 122.

In a case where the block variance value is large, the stereo distance reliability β is a higher value, that is, a value close to one. On the other hand, in a case where the variance value of the block is small, the stereo distance reliability β is a lower value, that is, a value close to zero.

(Step S106)

The processing in the next Step S106 is the processing executed by the TOF distance reliability determination unit 125 shown in FIG. 2.

In Step S106, the TOF distance reliability determination unit 125 determines whether or not the subject distance information generated by the TOF system distance calculation unit 123 is reliable data, generates the TOF reliability 207 including the determination information, and outputs the TOF reliability 207 to the subject distance information generation unit 126 as shown in FIG. 2.

Note that the TOF reliability 206 generated by the TOF distance reliability determination unit 125 includes reliability information for each of the subject distance information in pixel units or pixel region units generated by the TOF system distance calculation unit 123.

The reliability determination processing executed by the TOF distance reliability determination unit 125 is, for example, the processing previously described with reference to FIG. 5.

That is, the reliability is determined according to the input amount of the exogenous infrared light to the light receiving element at a time of non-irradiation of the infrared light by the infrared light (IR) irradiation unit 113.

A case where the received light intensity of the infrared light is large at a time of non-irradiation of the infrared light by the infrared light (IR) irradiation unit 113 means that there are a lot of infrared light of external factors such as sunlight, which means that it is difficult to measure the TOF distance accurately.

In such a case where the received light intensity is large at the time of non-irradiation of the infrared light by the infrared light (IR) irradiation unit 113, the reliability α of the TOF distance calculated by the TOF system distance calculation unit 123 is a lower value, that is, a value close to zero.

On the other hand, a case where the received light intensity is small at the time of non-irradiation of the infrared light by the infrared light (IR) irradiation unit 113 means that there is a little infrared light of external factors such as sunlight, which means that it is possible to measure the TOF distance accurately.

In such a case where the received light intensity is small at the time of non-irradiation of the infrared light by the infrared light (IR) irradiation unit 113, the reliability α of the TOF distance calculated by the TOF system distance calculation unit 123 is a higher value, that is, a value close to one.

The TOF distance reliability determination unit 125 calculates the reliability α of the TOF distance calculated by the TOF system distance calculation unit 123, for example, in pixel units or pixel region units.

This reliability information is the TOF reliability 207 shown in FIG. 2.

The TOF distance reliability determination unit 125 outputs the generated TOF reliability 207 to the subject distance information generation unit 126 as shown in FIG. 2.

(Step S107)

The processing in Step S107 is the processing executed by the subject distance information generation unit 126 shown in FIG. 2.

On the basis of the stereo distance reliability 206 and the TOF distance reliability 207, the subject distance information generation unit 126 confirms the reliabilities of the stereo distance information 204 and the TOF distance information 205, selects one of the distance information or generates the synthesizing result of the two distance information, and generates the information or the result as the final output distance information.

Note that this processing is executed in pixel units or pixel region units constituted by a predetermined number of pixels.

On the basis of the stereo reliability 206 and the TOF reliability 207, the subject distance information generation unit 126 selects any one of the distance information determined to have high reliability, or generates new distance information by the blending processing, and outputs either one of them as the final distance information, that is, the distance (depth) information 152.

These specific processing examples are as described with reference to FIGS. 6 to 9.

(Step S108)

Next, in Step S108, it is determined whether or not the generation of the final distance information has been completed for all the pixels.

In a case where there is a pixel which has not been completed, the processing returns to Step S105, and the processings in Step S105 and the followings are executed for the unprocessed pixel.

In Step S108, when it is determined that the generation of the final distance information has been completed for all the pixels, the processing ends.

At this point, the distance (depth) information 152 shown in FIG. 2 is outputted from the image processing unit 120.

This distance (depth) information 152 is distance (depth) information in which one of the following distance information of

(a) the stereo distance information,

(b) the TOF distance information, and

(c) the synthetic distance information of the stereo distance information and the TOF distance information,

is set in pixel units or pixel region units.

For the distance information associated with each pixel, distance information with high reliability is selected, and highly precise distance information is outputted for the entire image.

[3-2. About Processing Sequence Using One Reliability Information of Only TOF Distance Reliability]

Next, with reference to the flowchart shown in FIG. 11, the processing sequence using one reliability information of only the TOF distance reliability will be described.

Hereinafter, the processing in each step will be sequentially described.

(Steps S101 to S104)

The processings in Steps S101 to S104 are processings similar to the processings in Steps S101 to S104 previously described with reference to the flowchart in FIG. 10.

Step S101a is the capturing processing of the visible light image 200 in the first imaging unit 107 shown in FIG. 2.

Step S101b is the capturing processing of the visible light+infrared light image 201 in the second imaging unit 108 shown in FIG. 2.

Step S102 is the processing executed by the infrared light (IR) separation unit 121 shown in FIG. 2, which inputs the visible light+infrared light image 201 captured by the second imaging unit 108, executes the infrared light (IR) separation processing, and generates the visible light image 202 and the infrared light image 203 shown in FIG. 2.

The processing in Step S103 is the subject distance calculation processing according to the time of flight (TOF) system executed by the TOF system distance calculation unit 123 shown in FIG. 2. The subject distance (TOF distance) is calculated by utilizing the infrared light image 203 generated by the infrared light (IR) separation unit 121.

The processing in Step S104 is the processing executed by the stereo system distance calculation unit 122 shown in FIG. 2. The stereo system distance calculation unit 122 calculates the subject distance (stereo distance) by using the two image signals of the visible light image 200 captured by the first imaging unit 107 and the visible light image 202 obtained from the captured image of the second imaging unit 108.

Note that this distance calculation is executed in pixel units constituting the image or pixel region units including a plurality of pixels.

(Step S151)

The processing in the next Step S151 is the processing executed by the TOF distance reliability determination unit 125 shown in FIG. 2.

In Step S151, the TOF distance reliability determination unit 125 determines whether or not the subject distance information generated by the TOF system distance calculation unit 123 is reliable data, generates the TOF reliability 207 including the determination information, and outputs the TOF reliability 207 to the subject distance information generation unit 126 as shown in FIG. 2.

Note that the TOF reliability 206 generated by the TOF distance reliability determination unit 125 includes reliability information for each of the subject distance information in pixel units or pixel region units generated by the TOF system distance calculation unit 123.

The reliability determination processing executed by the TOF distance reliability determination unit 125 is, for example, the processing previously described with reference to FIG. 5.

That is, the reliability is determined according to the input amount of the exogenous infrared light to the light receiving element at a time of non-irradiation of the infrared light by the infrared light (IR) irradiation unit 113.

A case where the received light intensity of the infrared light is large at a time of non-irradiation of the infrared light by the infrared light (IR) irradiation unit 113 means that there are a lot of infrared light of external factors such as sunlight, which means that it is difficult to measure the TOF distance accurately.

In such a case where the received light intensity is large at the time of non-irradiation of the infrared light by the infrared light (IR) irradiation unit 113, the reliability α of the TOF distance calculated by the TOF system distance calculation unit 123 is a lower value, that is, a value close to zero.

On the other hand, a case where the received light intensity is small at the time of non-irradiation of the infrared light by the infrared light (IR) irradiation unit 113 means that there is a little infrared light of external factors such as sunlight, which means that it is possible to measure the TOF distance accurately.

In such a case where the received light intensity is small at the time of non-irradiation of the infrared light by the infrared light (IR) irradiation unit 113, the reliability α of the TOF distance calculated by the TOF system distance calculation unit 123 is a higher value, that is, a value close to one.

The TOF distance reliability determination unit 125 calculates the reliability α of the TOF distance calculated by the TOF system distance calculation unit 123, for example, in pixel units or pixel region units.

This reliability information is the TOF reliability 207 shown in FIG. 2.

The TOF distance reliability determination unit 125 outputs the generated TOF reliability 207 to the subject distance information generation unit 126 as shown in FIG. 2.

(Step S152)

The processing in Step S152 is the processing executed by the subject distance information generation unit 126 shown in FIG. 2.

On the basis of the TOF distance reliability 207, the subject distance information generation unit 126 generates one of the following distance information of

(a) the stereo distance information,

(b) the TOF distance information, and

(c) the synthetic distance information of the stereo distance information and the TOF distance information

as the final output distance information.

Note that this processing is executed in pixel units or pixel region units constituted by a predetermined number of pixels.

In the present example, the stereo reliability 206 is not used, but the output information is generated on the basis of only the TOF reliability 207 and outputted as the distance (depth) information 152.

(Step S153)

Next, in Step S153, it is determined whether or not the generation of the final distance information has been completed for all the pixels.

In a case where there is a pixel which has not been completed, the processing returns to Step S151, and the processings in Step S151 and the followings are executed for the unprocessed pixel.

In Step S153, when it is determined that the generation of the final distance information has been completed for all the pixels, the processing ends.

At this point, the distance (depth) information 152 shown in FIG. 2 is outputted from the image processing unit 120.

This distance (depth) information 152 is distance (depth) information in which one of the following distance information of

(a) the stereo distance information,

(b) the TOF distance information, and

(c) the synthetic distance information of the stereo distance information and the TOF distance information,

is set in pixel units or pixel region units.

For the distance information associated with each pixel, distance information with high reliability is selected, and highly precise distance information is outputted for the entire image.

[3-3. About Processing Sequence for Selecting One of Stereo Distance Information and TOF Distance Information in Pixel Unit as Final Distance Information by Using One Reliability Information of Only TOF Distance Reliability]

Next, with reference to the flowchart shown in FIG. 12, the processing sequence for selecting one of the stereo distance information and the TOF distance information in pixel units as the final distance information by using one reliability information of only the TOF distance reliability will be described.

Hereinafter, the processing in each step will be sequentially described.

(Steps S101 to S104)

The processings in Steps S101 to S104 are processings similar to the processings in Steps S101 to S104 previously described with reference to the flowchart in FIG. 10.

Step S101a is the capturing processing of the visible light image 200 in the first imaging unit 107 shown in FIG. 2.

Step S101b is the capturing processing of the visible light+infrared light image 201 in the second imaging unit 108 shown in FIG. 2.

Step S102 is the processing executed by the infrared light (IR) separation unit 121 shown in FIG. 2, which inputs the visible light+infrared light image 201 captured by the second imaging unit 108, executes the infrared light (IR) separation processing, and generates the visible light image 202 and the infrared light image 203 shown in FIG. 2.

The processing in Step S103 is the subject distance calculation processing according to the time of flight (TOF) system executed by the TOF system distance calculation unit 123 shown in FIG. 2. The subject distance (TOF distance) is calculated by utilizing the infrared light image 203 generated by the infrared light (IR) separation unit 121.

The processing in Step S104 is the processing executed by the stereo system distance calculation unit 122 shown in FIG. 2. The stereo system distance calculation unit 122 calculates the subject distance (stereo distance) by using the two image signals of the visible light image 200 captured by the first imaging unit 107 and the visible light image 202 obtained from the captured image of the second imaging unit 108.

Note that this distance calculation is executed in pixel units constituting the image or pixel region units including a plurality of pixels.

(Step S181)

The processing in the next Step S181 is the processing executed by the TOF distance reliability determination unit 125 shown in FIG. 2.

In Step S181, the TOF distance reliability determination unit 125 determines whether or not the subject distance information generated by the TOF system distance calculation unit 123 is reliable data, generates the TOF reliability 207 including the determination information, and outputs the TOF reliability 207 to the subject distance information generation unit 126 as shown in FIG. 2.

Note that the TOF reliability 206 generated by the TOF distance reliability determination unit 125 includes reliability information for each of the subject distance information in pixel units or pixel region units generated by the TOF system distance calculation unit 123.

The reliability determination processing executed by the TOF distance reliability determination unit 125 is, for example, the processing previously described with reference to FIG. 5.

That is, the reliability is determined according to the input amount of the exogenous infrared light to the light receiving element at a time of non-irradiation of the infrared light by the infrared light (IR) irradiation unit 113.

A case where the received light intensity of the infrared light is large at a time of non-irradiation of the infrared light by the infrared light (IR) irradiation unit 113 means that there are a lot of infrared light of external factors such as sunlight, which means that it is difficult to measure the TOF distance accurately.

In such a case where the received light intensity is large at the time of non-irradiation of the infrared light by the infrared light (IR) irradiation unit 113, the reliability α of the TOF distance calculated by the TOF system distance calculation unit 123 is a lower value, that is, a value close to zero.

On the other hand, a case where the received light intensity is small at the time of non-irradiation of the infrared light by the infrared light (IR) irradiation unit 113 means that there is a little infrared light of external factors such as sunlight, which means that it is possible to measure the TOF distance accurately.

In such a case where the received light intensity is small at the time of non-irradiation of the infrared light by the infrared light (IR) irradiation unit 113, the reliability α of the TOF distance calculated by the TOF system distance calculation unit 123 is a higher value, that is, a value close to one.

The TOF distance reliability determination unit 125 calculates the reliability α of the TOF distance calculated by the TOF system distance calculation unit 123, for example, in pixel units or pixel region units.

This reliability information is the TOF reliability 207 shown in FIG. 2.

The TOF distance reliability determination unit 125 outputs the generated TOF reliability 207 to the subject distance information generation unit 126 as shown in FIG. 2.

(Step S182)

The processings in Steps S5182 to S184 are the processings executed by the subject distance information generation unit 126 shown in FIG. 2.

On the basis of the TOF distance reliability 207, the subject distance information generation unit 126 generates one of the following distance information of

(a) the stereo distance information, and

(b) the TOF distance information,

as the final output distance information.

Note that this processing is executed in pixel units or pixel region units constituted by a predetermined number of pixels.

In the present example, the processing of synthesizing the stereo distance information and the TOF distance information is not executed, but one of the stereo distance information and the TOF distance information is selected in pixel units as the final output distance information.

In Step S182, it is determined whether or not the TOF reliability 207 is low, that is, the TOF reliability 207 is less than the predetermined threshold value. In a case where it is determined that the TOF reliability 207 is less than the predetermined threshold value and low, the processing proceeds to Step S183.

On the other hand, in a case where it is determined that the TOF reliability 207 is not low, that is, the TOF reliability 207 is equal to or greater than the predetermined threshold value and it is determined that the TOF reliability 207 is high, the processing proceeds to Step S184.

(Step S183)

In a case where it is determined in Step S182 that the TOF reliability 207 is low, the subject distance information generation unit 126 selects the stereo distance information as the final output distance information in Step S183.

(Step S184)

On the other hand, in a case where it is determined in Step S182 that the TOF reliability 207 is not low, the subject distance information generation unit 126 selects the TOF distance information as the final output distance information in Step S184.

(Step S185)

Next, in Step S185, it is determined whether or not the generation of the final distance information has been completed for all the pixels.

In a case where there is a pixel which has not been completed, the processing returns to Step S181, and the processings in Step S181 and the followings are executed for the unprocessed pixel.

In Step S185, when it is determined that the generation of the final distance information has been completed for all the pixels, the processing ends.

At this point, the distance (depth) information 152 shown in FIG. 2 is outputted from the image processing unit 120.

This distance (depth) information 152 is distance (depth) information in which one of the following distance information of

(a) the stereo distance information, and

(b) the TOF distance information,

is set in pixel units or pixel region units.

For the distance information associated with each pixel, distance information with high reliability is selected, and highly precise distance information is outputted for the entire image.

[4. About Configuration and Processings of Image Processing Unit Which Generates Synthetic Image with Improved Image Quality]

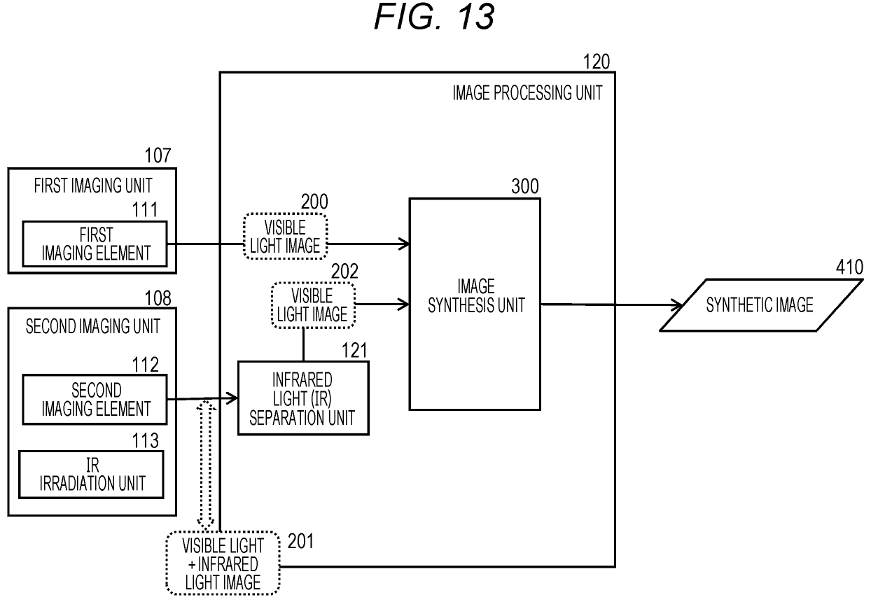

Next, with reference to FIG. 13 and the followings, the configuration and processings of the image processing unit, which generates a synthetic image with improved image quality, will be described.

As previously mentioned, the image processing unit 120 inputs the two images inputted from the imaging unit 106, applies these two images and generates the distance (depth) information 152 indicating the subject distance (depth) as well as generates the image 151 as an image with high image quality, in which noise is reduced, by synthesizing the two images.

Hereinafter, the generation processing of the synthetic image with improved image quality in the image processing unit 120 will be described.

FIG. 13 is a block diagram showing the partial configuration of the image processing unit 120 of the image processing apparatus 100.

FIG. 13 shows a configuration applied to the generation processing of a synthetic image 410 among the configuration of the image processing unit 120.

As shown in FIG. 13, the image processing unit 120 has the infrared light (IR) separation unit 121 and an image synthesis unit 300.

The input signal into the image processing unit 120 is each of the following signals.

(1) A visible light image 200 inputted from the first imaging unit 107, and

(2) a visible light+infrared light image 201 inputted from the second imaging unit 108.

First, the infrared light (IR) separation unit 121 inputs the visible light+infrared light image 201 inputted from the second imaging unit 108 and executes infrared light (IR) separation processing on the visible light+infrared light image 201.

The infrared light (IR) separation processing executed by the infrared light (IR) separation unit 121 is the processing previously described with reference to FIG. 3.

The following images are inputted into the image synthesis unit 300.

(1) The visible light image 200 which is the captured image of the first imaging unit 107, and

(2) the visible light image 202 generated from the captured image of the second imaging unit 108.

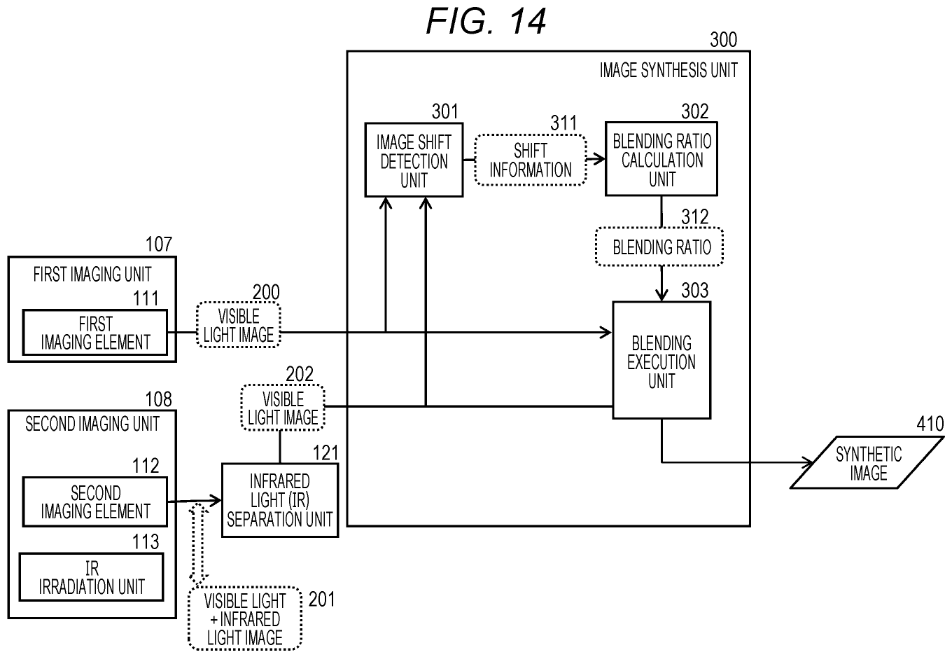

The configuration and processing example of the image synthesis unit 300 will be described with reference to FIG. 14.

As shown in FIG. 14, the image synthesis unit 300 has an image shift detection unit 301, a blending ratio calculation unit 302 and a blending execution unit 303.

The image shift detection unit 301 inputs the following two images.

(1) The visible light image 200 which is the captured image of the first imaging unit 107, and

(2) the visible light image 202 generated from the captured image of the second imaging unit 108.

The image shift detection unit 301 detects the positional shift of the image for these two images. The positional shift amount in pixel units is calculated, and shift information 311 including shift amount data in pixel units is generated and outputted to the blending ratio calculation unit 302.

The blending ratio calculation unit 302 calculates the blending ratio of the pixels at the corresponding positions, that is, at the same coordinate positions of the two images, that is, the following two images of

(1) the visible light image 200 which is the captured image of the first imaging unit 107, and

(2) the visible light image 202 generated from the captured image of the second imaging unit 108,

on the basis of the “shift information 311” inputted from the image shift detection unit 301, that is, the shift amount in pixel units.

Specifically, a high blending ratio is set for a pixel with a small shift amount, and a small blending ratio is set for a pixel with a large shift amount.

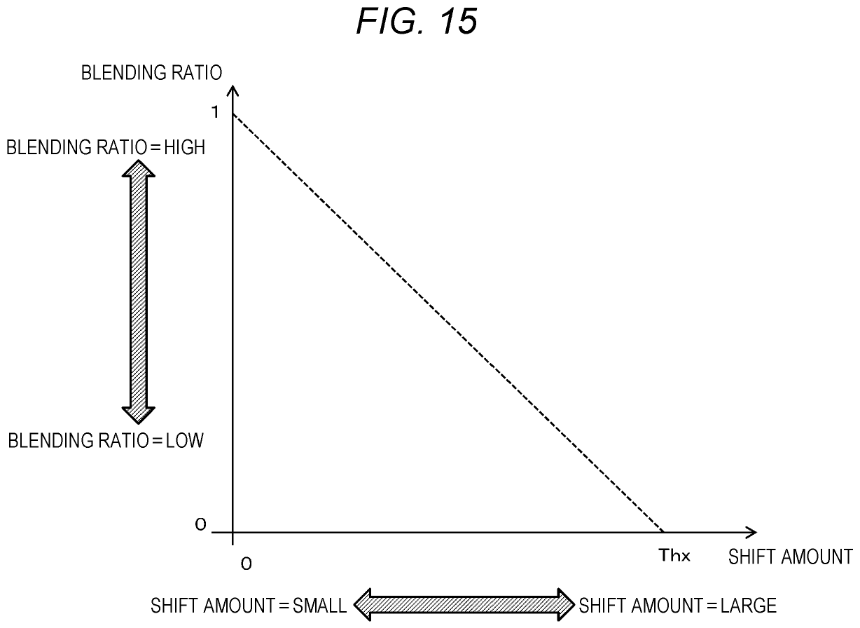

For example, the blending ratio is decided by the setting as shown in the graph in FIG. 15.

In the graph shown in FIG. 15, the horizontal axis is the positional shift amount of the corresponding pixels of the two images, and the vertical axis is the blending ratio.

Blending ratio=1 indicates that the pixels at the corresponding positions of the two images are blended (synthesized) by 1:1. Blending ratio=0 means that pixel values of one image are directly outputted without being blended.

Thus, the blending ratio calculation unit 302 calculates the blending ratio of the pixels at the corresponding positions, that is, at the same coordinate positions of the two images on the basis of the “shift information 311” inputted from the image shift detection unit 301, that is, the shift amount in pixel units.

As shown in FIG. 14, the calculated blending ratio 312 is outputted to the blending execution unit 303.

The blending execution unit 303 executes the blending processing of the pixels at the corresponding positions, that is, at the same coordinate positions of two images on the basis of the “shift information 311” inputted from the blending ratio calculation unit 302, that is, the shift amount in pixel units, and generates and outputs an synthetic image 410.

The synthetic image 410 becomes a high-quality image, in which noise is reduced, by synthesizing the two images.

Note that the level of image quality improvement expected by this synthesis processing varies depending on the configuration of the imaging elements of the imaging units which capture images.

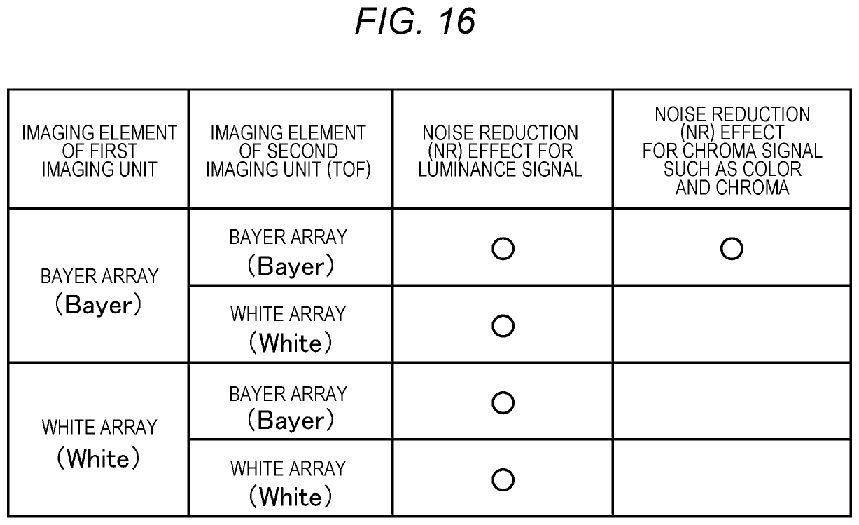

The correspondence between the configuration of the imaging elements and the expected image quality improvement aspect will be described with reference to FIG. 16.

FIG. 16 shows the image quality improvement aspects realized by the above synthesis processing of the two images in a case of the four combinations in which a case where the first imaging unit and the second imaging unit are each the Bayer array, that is, the RGB pixel array, and a case where the first imaging unit and the second imaging unit are each the white array, that is, the WB pixel array.

In a case where both of the two imaging units are the Bayer arrays, the noise reduction effect can be obtained for both signals of the luminance signal and the chroma signal (color, chroma).

In addition, in a case where at least one of the imaging unit has an imaging element of the white array, the noise reduction effect can be obtained for only the luminance signal.

[5. About Synthetic Image Generation Processing Sequence Executed by Image Processing Apparatus]

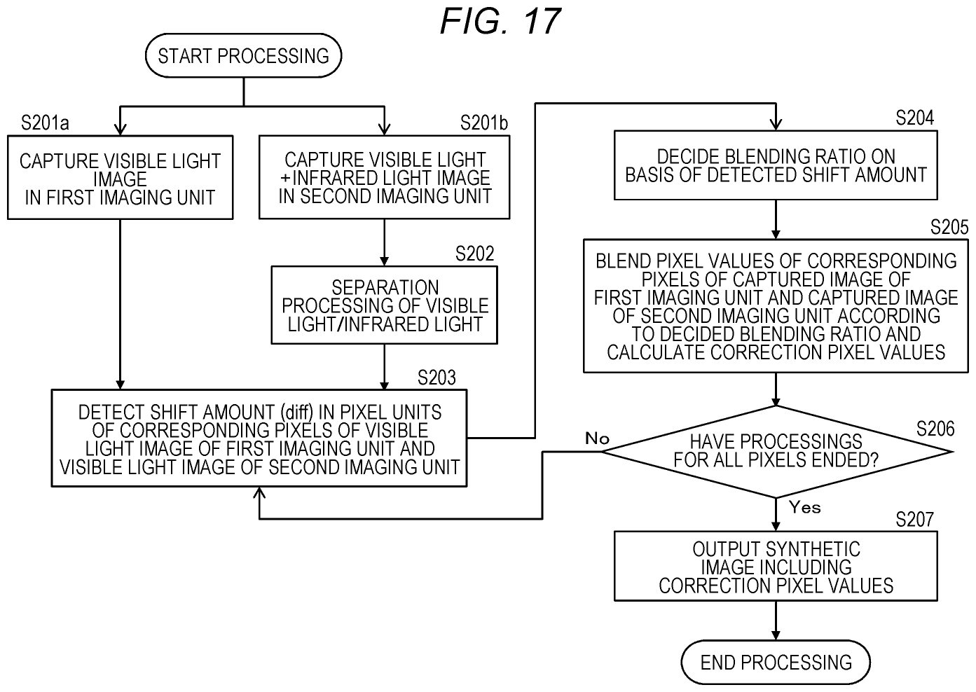

Next, with reference to a flowchart shown in FIG. 17, the generation processing sequence of the synthetic image with improved image quality executed by the image processing apparatus will be described.

Hereinafter, the processing in each step will be sequentially described.

(Step S201)

Step S201a is the capturing processing of the visible light image 200 in the first imaging unit 107 shown in FIG. 2.

Step S201b is the capturing processing of the visible light+infrared light image 201 in the second imaging unit 108 shown in FIG. 2.

(Step S202)

Step S202 is the processing executed by the infrared light (IR) separation unit 121 shown in FIG. 2, which inputs the visible light+infrared light image 201 captured by the second imaging unit 108, executes the infrared light (IR) separation processing, and generates the visible light image 202 and the infrared light image 203 shown in FIG. 2.

As shown in FIGS. 13 and 14, the following images are inputted into the image synthesis unit 300.

(1) The visible light image 200 which is the captured image of the first imaging unit 107, and

(2) the visible light image 202 generated from the captured image of the second imaging unit 108.

(Step S203)

The processing in Step S203 is the processing executed by the image shift detection unit 301 of the image synthesis unit 300 shown in FIG. 14.

The image shift detection unit 301 inputs the following two images.

(1) The visible light image 200 which is the captured image of the first imaging unit 107, and

(2) the visible light image 202 generated from the captured image of the second imaging unit 108.

The image shift detection unit 301 detects the positional shift of the image for these two images. The positional shift amount in pixel units is calculated, and shift information 311 including shift amount data in pixel units is generated and outputted to the blending ratio calculation unit 302.

(Step S204)

The processing in Step S204 is the processing executed by the blending ratio calculation unit 302 of the image synthesis unit 300 shown in FIG. 14.

The blending ratio calculation unit 302 calculates the blending ratio of the pixels at the corresponding positions, that is, at the same coordinate positions of the two images, that is, the following two images of

(1) the visible light image 200 which is the captured image of the first imaging unit 107, and

(2) the visible light image 202 generated from the captured image of the second imaging unit 108,

on the basis of the “shift information 311” inputted from the image shift detection unit 301, that is, the shift amount in pixel units.

Specifically, a high blending ratio is set for a pixel with a small shift amount, and a small blending ratio is set for a pixel with a large shift amount. The calculated blending ratio 312 is outputted to the blending execution unit 303.

(Step S205)

The processing in Step S205 is the processing executed by the blending execution unit 303 of the image synthesis unit 300 shown in FIG. 14.

The blending execution unit 303 executes the blending processing of the pixels at the corresponding positions, that is, at the same coordinate positions of two images on the basis of the “shift information 311” inputted from the blending ratio calculation unit 302, that is, the shift amount in pixel units, and calculates a correction pixel value of each pixel.

(Step S206)

Next, in Step S206, it is determined whether or not the correction pixel value calculation has been completed for all the pixels.

In a case where there is a pixel which has not been completed, the processing returns to Step S203, and the processings in Step S203 and the followings are executed for the unprocessed pixel.

When it is determined in Step 206 that the correction pixel value calculation has been completed for all the pixels, the processing proceeds to Step S207.

(Step S207)

When the correction pixel value calculation has been completed for all the pixels, the blending execution unit 303 of the image synthesis unit 300 shown in FIG. 14 generates the synthetic image 410, in which the correction pixel values is set, to be outputted.

The synthetic image 410 becomes a high-quality image, in which noise is reduced, by synthesizing the two images.

[6. Summary of Configurations of Present Disclosure]

The examples of the present disclosure have been described in detail above with reference to specific examples. However, it is obvious that those skilled in the art can make modifications and substitutions of the examples in a scope without departing from the gist of the present disclosure. That is, the present invention has been disclosed in the form of exemplification and should not be interpreted restrictively. In order to judge the gist of the present disclosure, the scope of claims should be taken into consideration.

Note that the technology disclosed in this specification can adopt the following configurations.

(1) An image processing apparatus including:

an image processing unit which inputs a first image and a second image, which are captured images from two different viewpoints, and generates distance information which indicates a subject distance,

in which the image processing unit includes:

a time of flight (TOF) system distance calculation unit which calculates a TOF distance, which is the subject distance according to a TOF system, by utilizing an infrared light component of the second image;

a stereo system distance calculation unit which calculates a stereo distance, which is the subject distance according to a stereo system, by utilizing the first image and a visible light component of the second image;

a TOF distance reliability determination unit which determines reliability of the TOF distance; and

a subject distance information generation unit which generates, as final distance information, the stereo distance or synthetic distance information of the TOF distance and the stereo distance, for a pixel region in which the reliability of the TOF distance is low.

(2) The image processing apparatus according to (1), further including:

an infrared light separation unit which separates the second image into a visible light component image and an infrared light component image,

in which the TOF system distance calculation unit executes subject distance calculation processing by utilizing the infrared light component image generated by the infrared light separation unit, and

the stereo system distance calculation unit executes subject distance calculation processing by utilizing the visible light component image generated by the infrared light separation unit.

(3) The image processing apparatus according to (1) or (2), in which the TOF distance reliability determination unit determines the reliability of the TOF distance according to an amount of an infrared light component included in the second image which is a captured image of the second imaging unit at a time of non-irradiation of infrared light.

(4) The image processing apparatus according to any one of (1) to (3), further including:

a stereo distance reliability determination unit which determines reliability of the stereo distance which is the subject distance calculated by the stereo system distance calculation unit,

in which the subject distance information generation unit generates, as the final distance information, the TOF distance or distance information calculated by synthesis processing of the TOF distance and the stereo distance, for a pixel region in which the reliability of the stereo distance is low.

(5) The image processing apparatus according to (4), in which the stereo distance reliability determination unit determines the reliability of the stereo distance according to a variance value of a pixel value of a block configuration pixel applied to block matching processing in the stereo system distance calculation unit.

(6) The image processing apparatus according to any one of (1) to (5), in which the subject distance information generation unit generates, as the final distance information, one of following (a) to (c) distance information of:

(a) the stereo distance,

(b) the TOF distance, and

(c) a synthetic distance of the stereo distance and the TOF distance,

in pixel unit or pixel region unit according to the reliability of the TOF distance in the pixel unit or the pixel region unit.

(7) The image processing apparatus according to any one of (1) to (6), in which the subject distance information generation unit generates, as the final distance information, one of following (a) to (c) distance information of:

(a) the stereo distance,

(b) the TOF distance, and

(c) the synthetic distance of the stereo distance and the TOF distance,

in the pixel unit or the pixel region unit according to the reliability of the stereo distance in the pixel unit or the pixel region unit.

(8) An imaging apparatus including:

a first imaging unit which captures a first image constituted by a visible light component;

a second imaging unit which captures a second image including a visible light component and an infrared light component; and

an image processing unit which inputs the first image and the second image and generates distance information which indicates a subject distance,

in which the image processing unit includes:

a time of flight (TOF) system distance calculation unit which executes subject distance calculation according to a TOF system by utilizing the second image;

a stereo system distance calculation unit which executes subject distance calculation according to a stereo system by utilizing the first image and the second image;

a TOF distance reliability determination unit which determines reliability of a TOF distance which is the subject distance calculated by the TOF system distance calculation unit; and

a subject distance information generation unit which generates final distance information on the basis of the reliability of the TOF distance, and

the subject distance information generation unit generates, as the final distance information, the stereo distance, which is the subject distance according to the stereo system, or the distance information calculated by synthesis processing of the TOF distance and the stereo distance, for a pixel region in which the reliability of the TOF distance is low.

(9) An image processing apparatus including:

an image processing unit which inputs a first image and a second image, which are captured images from two different viewpoints, and generates a synthetic image,

in which the first image is an image constituted by a visible light component,

the second image is an image including a visible light component and an infrared light component, and

the image processing unit includes:

an infrared light separation unit which separates the second image into a visible light component image and an infrared light component image; and

an image synthesis unit which executes synthesis processing of the first image and the visible light component image generated on the basis of the second image by the infrared light separation unit.

(10) The image processing apparatus according to (9), in which the image synthesis unit includes:

an image shift calculation unit which calculates a positional shift amount in pixel unit of the first image and the visible light component image generated on the basis of the second image by the infrared light separation unit;

a blending ratio calculation unit which calculates, according to the positional shift amount calculated by the image shift calculation unit, a blending ratio in the pixel unit of the first image and the visible light component image generated on the basis of the second image by the infrared light separation unit; and

a blending execution unit which executes, according to the blending ratio calculated by the blending ratio calculation unit, blending processing in the pixel unit of the first image and the visible light component image generated on the basis of the second image by the infrared light separation unit.

(11) The image processing apparatus according to (9) or (10), further including a time of flight (TOF) system distance calculation unit which executes subject distance calculation according to a TOF system by utilizing the second image.

(12) The image processing apparatus according to any one of (9) to (11), further including a stereo system distance calculation unit which executes subject distance calculation according to a stereo system by utilizing the first image and the second image.

(13) An image processing method executed in an image processing apparatus,

in which the image processing apparatus includes:

an image processing unit which inputs a first image and a second image, which are captured images from two different viewpoints, and generates distance information which indicates a subject distance, and

the image processing unit executes:

time of flight (TOF) system distance calculation processing which calculates a TOF distance, which is the subject distance according to a TOF system, by utilizing an infrared light component of the second image;

stereo system distance calculation processing which calculates a stereo distance, which is the subject distance according to a stereo system, by utilizing the first image and a visible light component of the second image;

TOF distance reliability determination processing which determines reliability of the TOF distance; and

subject distance information generation processing which generates, as final distance information, the stereo distance or synthetic distance information of the TOF distance and the stereo distance, for a pixel region in which the reliability of the TOF distance is low.

(14) An image processing method executed in an image processing apparatus,

in which the image processing apparatus includes:

an image processing unit which inputs a first image and a second image, which are captured images from two different viewpoints, and generates a synthetic image,

the first image is an image constituted by a visible light component,

the second image is an image including a visible light component and an infrared light component, and

the image processing unit executes:

infrared light separation processing which separates the second image into a visible light component image and an infrared light component image; and

synthesis processing of the first image and the visible light component image generated on the basis of the second image.

(15) A program for causing an image processing apparatus to execute image processing,

in which the image processing apparatus includes:

an image processing unit which inputs a first image and a second image, which are captured images from two different viewpoints, and generates distance information which indicates a subject distance, and

the program causes the image processing unit to execute:

time of flight (TOF) system distance calculation processing which calculates a TOF distance, which is the subject distance according to a TOF system, by utilizing an infrared light component of the second image;

stereo system distance calculation processing which calculates a stereo distance, which is the subject distance according to a stereo system, by utilizing the first image and a visible light component of the second image;

TOF distance reliability determination processing which determines reliability of the TOF distance; and

subject distance information generation processing which generates, as final distance information, the stereo distance or synthetic distance information of the TOF distance and the stereo distance, for a pixel region in which the reliability of the TOF distance is low.

(16) A program for causing an image processing apparatus to execute image processing,

in which the image processing apparatus includes:

an image processing unit which inputs a first image and a second image, which are captured images from two different viewpoints, and generates a synthetic image,

the first image is an image constituted by a visible light component,

the second image is an image including a visible light component and an infrared light component, and

the program causes the image processing unit to execute:

infrared light separation processing which separates the second image into a visible light component image and an infrared light component image; and

synthesis processing of the first image and the visible light component image generated on the basis of the second image.

Moreover, the series of processings described in the specification can be executed by hardware, software or a composite configuration thereof. In the case of executing the processings by software, it is possible to install a program, in which the processing sequences are recorded, in a memory inside a computer incorporated into dedicated hardware and cause the program to be executed or to install the program in a general-purpose computer, which can execute various processings, and cause the program to be executed. For example, the program can be prerecorded on a recording medium. Besides installing the program in the computer from the recording medium, it is possible to receive the program via a network such as local area network (LAN) and the Internet and install the program on a recording medium such as an incorporated hard disk.

Note that the various processings described in the specification are not only executed in time series according to the description but also may be executed in parallel or individually according to the processing capability of the apparatus which executes the processings or as necessary. Furthermore, the term “system” in this specification refers to a logical group configuration of a plurality of apparatuses and is not limited to a system in which the apparatus of each configuration is in the same housing.

### INDUSTRIAL APPLICABILITY

As described above, according to the configuration of one example of the present disclosure, the apparatus and the method for generating accurate distance information of a subject are realized.

Specifically, the apparatus has an image processing unit which inputs a first image constituted by a visible light component and a second image including a visible light component and an infrared light component to calculate a subject distance, in which the image processing unit calculates two distance information of a TOF distance, which is the subject distance calculated according to a TOF system by utilizing the second image, and a stereo distance calculated according to a stereo system by utilizing the first image and the second image, determines TOF distance reliability indicating reliability of the TOF distance, and generates, as final distance information, the stereo distance, which is the subject distance according to the stereo system, or distance information calculated by synthesis processing of the TOF distance and the stereo distance, for a pixel region in which the reliability of the TOF distance is low.

By these processings, the apparatus and the method for generating the accurate distance information of the subject are realized.

### REFERENCE SIGNS LIST

100 Image processing apparatus
101 Control unit
102 Storage unit
103 Codec
104 Input unit
105 Output unit
106 Imaging unit
107 First imaging unit
108 Second imaging unit
111 First imaging element
112 Second imaging element
113 Infrared light (IR) irradiation unit
120 Image processing unit
121 Infrared light (IR) separation unit
122 Stereo system distance calculation unit
123 TOF system distance calculation unit
124 Stereo distance reliability determination unit
125 TOF distance reliability determination unit
126 Subject distance information generation unit
151 Image
152 Distance (depth) information
300 Image synthesis unit
301 Image shift detection unit
302 Blending ratio calculation unit
303 Blending execution unit
410 Synthetic image

1. An image processing apparatus comprising:
an image processing unit which inputs a first image and a second image, which are captured images from two different viewpoints, and generates distance information which indicates a subject distance,
wherein the image processing unit comprises:
a time of flight (TOF) system distance calculation unit which calculates a TOF distance, which is the subject distance according to a TOF system, by utilizing an infrared light component of the second image;
a stereo system distance calculation unit which calculates a stereo distance, which is the subject distance according to a stereo system, by utilizing the first image and a visible light component of the second image;
a TOF distance reliability determination unit which determines reliability of the TOF distance; and
a subject distance information generation unit which generates, as final distance information, the stereo distance or synthetic distance information of the TOF distance and the stereo distance, for a pixel region in which the reliability of the TOF distance is low.

2. The image processing apparatus according to claim 1, further comprising:
an infrared light separation unit which separates the second image into a visible light component image and an infrared light component image,
wherein the TOF system distance calculation unit executes subject distance calculation processing by utilizing the infrared light component image generated by the infrared light separation unit, and
the stereo system distance calculation unit executes subject distance calculation processing by utilizing the visible light component image generated by the infrared light separation unit.

3. The image processing apparatus according to claim 1, wherein the TOF distance reliability determination unit determines the reliability of the TOF distance according to an amount of an infrared light component included in the second image which is a captured image of the second imaging unit at a time of non-irradiation of infrared light.

4. The image processing apparatus according to claim 1, further comprising:
a stereo distance reliability determination unit which determines reliability of the stereo distance which is the subject distance calculated by the stereo system distance calculation unit,
wherein the subject distance information generation unit generates, as the final distance information, the TOF distance or distance information calculated by synthesis processing of the TOF distance and the stereo distance, for a pixel region in which the reliability of the stereo distance is low.

5. The image processing apparatus according to claim 4, wherein the stereo distance reliability determination unit determines the reliability of the stereo distance according to a variance value of a pixel value of a block configuration pixel applied to block matching processing in the stereo system distance calculation unit.

6. The image processing apparatus according to claim 1, wherein the
subject distance information generation unit generates, as the final distance information, one of following (a) to (c) distance information of:
(a) the stereo distance,
(b) the TOF distance, and
(c) a synthetic distance of the stereo distance and the TOF distance,
in pixel unit or pixel region unit according to the reliability of the TOF distance in the pixel unit or the pixel region unit.

7. The image processing apparatus according to claim 4, wherein the
subject distance information generation unit generates, as the final distance information, one of following (a) to (c) distance information of:
(a) the stereo distance,
(b) the TOF distance, and
(c) a synthetic distance of the stereo distance and the TOF distance,
in pixel unit or pixel region unit according to the reliability of the stereo distance in the pixel unit or the pixel region unit.

8. An imaging apparatus comprising:
a first imaging unit which captures a first image constituted by a visible light component;
a second imaging unit which captures a second image including a visible light component and an infrared light component; and
an image processing unit which inputs the first image and the second image and generates distance information which indicates a subject distance,
wherein the image processing unit comprises:
a time of flight (TOF) system distance calculation unit which executes subject distance calculation according to a TOF system by utilizing the second image;
a stereo system distance calculation unit which executes subject distance calculation according to a stereo system by utilizing the first image and the second image;
a TOF distance reliability determination unit which determines reliability of a TOF distance which is the subject distance calculated by the TOF system distance calculation unit; and
a subject distance information generation unit which generates final distance information on the basis of the reliability of the TOF distance, and
the subject distance information generation unit generates, as the final distance information, the stereo distance, which is the subject distance according to the stereo system, or the distance information calculated by synthesis processing of the TOF distance and the stereo distance, for a pixel region in which the reliability of the TOF distance is low.

9. An image processing apparatus comprising:
an image processing unit which inputs a first image and a second image, which are captured images from two different viewpoints, and generates a synthetic image,
wherein the first image is an image constituted by a visible light component,
the second image is an image including a visible light component and an infrared light component, and
the image processing unit comprises:
an infrared light separation unit which separates the second image into a visible light component image and an infrared light component image; and
an image synthesis unit which executes synthesis processing of the first image and the visible light component image generated on the basis of the second image by the infrared light separation unit.

10. The image processing apparatus according to claim 9, wherein the image synthesis unit comprises:
an image shift calculation unit which calculates a positional shift amount in pixel unit of the first image and the visible light component image generated on the basis of the second image by the infrared light separation unit;
a blending ratio calculation unit which calculates, according to the positional shift amount calculated by the image shift calculation unit, a blending ratio in the pixel unit of the first image and the visible light component image generated on the basis of the second image by the infrared light separation unit; and
a blending execution unit which executes, according to the blending ratio calculated by the blending ratio calculation unit, blending processing in the pixel unit of the first image and the visible light component image generated on the basis of the second image by the infrared light separation unit.

11. The image processing apparatus according to claim 9, further comprising a time of flight (TOF) system distance calculation unit which executes subject distance calculation according to a TOF system by utilizing the second image.

12. The image processing apparatus according to claim 9, further comprising a stereo system distance calculation unit which executes subject distance calculation according to a stereo system by utilizing the first image and the second image.

13. An image processing method executed in an image processing apparatus,
wherein the image processing apparatus comprises:
an image processing unit which inputs a first image and a second image, which are captured images from two different viewpoints, and generates distance information which indicates a subject distance, and
the image processing unit executes:
time of flight (TOF) system distance calculation processing which calculates a TOF distance, which is the subject distance according to a TOF system, by utilizing an infrared light component of the second image;
stereo system distance calculation processing which calculates a stereo distance, which is the subject distance according to a stereo system, by utilizing the first image and a visible light component of the second image;
TOF distance reliability determination processing which determines reliability of the TOF distance; and
subject distance information generation processing which generates, as final distance information, the stereo distance or synthetic distance information of the TOF distance and the stereo distance, for a pixel region in which the reliability of the TOF distance is low.

14. An image processing method executed in an image processing apparatus,
wherein the image processing apparatus comprises:
an image processing unit which inputs a first image and a second image, which are captured images from two different viewpoints, and generates a synthetic image,
the first image is an image constituted by a visible light component,
the second image is an image including a visible light component and an infrared light component, and
the image processing unit executes:
infrared light separation processing which separates the second image into a visible light component image and an infrared light component image; and
synthesis processing of the first image and the visible light component image generated on the basis of the second image.

15. A program for causing an image processing apparatus to execute image processing,
wherein the image processing apparatus comprises:
an image processing unit which inputs a first image and a second image, which are captured images from two different viewpoints, and generates distance information which indicates a subject distance, and
the program causes the image processing unit to execute:
time of flight (TOF) system distance calculation processing which calculates a TOF distance, which is the subject distance according to a TOF system, by utilizing an infrared light component of the second image;
stereo system distance calculation processing which calculates a stereo distance, which is the subject distance according to a stereo system, by utilizing the first image and a visible light component of the second image;
TOF distance reliability determination processing which determines reliability of the TOF distance; and
subject distance information generation processing which generates, as final distance information, the stereo distance or synthetic distance information of the TOF distance and the stereo distance, for a pixel region in which the reliability of the TOF distance is low.

16. A program for causing an image processing apparatus to execute image processing,
wherein the image processing apparatus comprises:
an image processing unit which inputs a first image and a second image, which are captured images from two different viewpoints, and generates a synthetic image,
the first image is an image constituted by a visible light component,
the second image is an image including a visible light component and an infrared light component, and
the program causes the image processing unit to execute:
infrared light separation processing which separates the second image into a visible light component image and an infrared light component image; and
synthesis processing of the first image and the visible light component image generated on the basis of the second image.
